(19) United States
(12) Patent Application Publication
(10) Pub. No.: US 2015/0273624 A1
(43) Pub. Date: Oct. 1, 2015

(54) LASER JOINING METHOD, LASER-JOINED COMPONENT, AND LASER JOINING APPARATUS

(71) Applicant: AISIN SEIKI KABUSHIKI KAISHA, Kariya-shi (JP)

(72) Inventor: Takashi YOSHIDA, Anjo-shi (JP)

(73) Assignee: AISIN SEIKI KABUSHIKI KAISHA, Kariya-shi (JP)

(21) Appl. No.: 14/670,669

(22) Filed: Mar. 27, 2015

(30) Foreign Application Priority Data
Mar. 31, 2014 (JP) 2014-070894

(51) Int. Cl. B23K 26/06; B23K 26/00; C03C 27/00; B32B 7/04; C03B 23/20; B32B 15/00; B32B 17/00; B32B 18/00; B23K 26/32; C03C 27/02

(52) U.S. Cl. CPC B23K 26/0635; B23K 26/3273; B23K 26/0608; B23K 26/0042; C03C 27/00; C03C 27/02; C03B 23/20; B32B 15/00; B32B 17/00; B32B 18/00; B32B 7/045; B32B 2457/14

(57) ABSTRACT

A laser joining method includes irradiating a first laser light serving as one of a laser light including a pulse width greater than an ultrashort-pulse laser light and a continuous wave laser light to a region at which a first object and a second object are in contact with or close to each other, and irradiating a second laser light serving as the ultrashort-pulse laser light during the irradiation of the first laser light to a section to which the first laser light is irradiated. An intensity of the second laser light falls within a range so that the first object and the second object are inhibited from being joined to each other in a case where the second laser light is independently irradiated to the region at which the first object and the second object are in contact with or close to each other.

### CROSS REFERENCE TO RELATED APPLICATIONS

This application is based on and claims priority under 35 U.S.C. §119 to Japanese Patent Application 2014-070894, filed on Mar. 31, 2014, the entire content of which is incorporated herein by reference.

### TECHNICAL FIELD

This disclosure generally relates to a laser joining method, a laser-joined component, and a laser joining apparatus.

### BACKGROUND DISCUSSION

A technique for laser joining of two objects by multi-photon absorption that occurs at a time of an irradiation of a femtosecond laser is disclosed, for example, in JP4230826B, JP4709482B, WO2011/115243, and T. Tamaki et al., “Welding of Transparent Materials Using Femtosecond Laser Pulses” Japanese Journal of Applied Physics, Vol. 44, No. 22, 2005, pp. L687-L689. The laser joining gains remarkable attention because simply irradiating the laser to two objects achieves the joining thereof.

Nevertheless, in order to obtain the multi-photon absorption, it is necessary to employ a femtosecond laser light source producing a high output. The femtosecond laser light source with the high output is extremely expensive, which may inhibit a cost reduction of laser joining.

A need thus exists for a laser joining method, a laser-joined component, and a laser joining apparatus which are not susceptible to the drawback mentioned above.

### SUMMARY

According to an aspect of this disclosure, a laser joining method includes irradiating a first laser light serving as one of a laser light including a pulse width greater than an ultrashort-pulse laser light and a continuous wave laser light to a region at which a first object and a second object are in contact with or close to each other, and irradiating a second laser light serving as the ultrashort-pulse laser light during the irradiation of the first laser light to a section to which the first laser light is irradiated for joining the first object and the second object to each other by laser joining. An intensity of the second laser light falls within a range so that the first object and the second object are inhibited from being joined to each other in a case where the second laser light is independently irradiated to the region at which the first object and the second object are in contact with or close to each other.

According to another aspect of this disclosure, a laser-joined component is obtained by a laser joining method, the laser joining method including irradiating a first laser light serving as one of a laser light including a pulse width greater than an ultrashort-pulse laser light and a continuous wave laser light to a region at which a first object and a second object are in contact with or close to each other, and irradiating a second laser light serving as the ultrashort-pulse laser light during the irradiation of the first laser light to a section to which the first laser light is irradiated for joining the first object and the second object to each other by laser joining. An intensity of the second laser light falls within a range so that the first object and the second object are inhibited from being joined to each other in a case where the second laser light is independently irradiated to the region at which the first object and the second object are in contact with or close to each other.

According to further aspect of this disclosure, a laser joining apparatus includes a first laser light source emitting a first laser light serving as one of a laser light including a pulse width greater than an ultrashort-pulse laser light and a continuous wave laser light, a second laser light source emitting a second laser light serving as the ultrashort-pulse laser light, and a control portion irradiating the first laser light to a region at which a first object and a second object are in contact with or close to each other and irradiating the second laser light during the irradiation of the first laser light to a section to which the first laser light is irradiated. An intensity of the second laser light falls within a range so that the first object and the second object are inhibited from being joined to each other in a case where the second laser light is independently irradiated to the region at which the first object and the second object are in contact with or close to each other.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view illustrating a laser joining apparatus according to a first embodiment disclosed here;

FIG. 2 is a time chart schematically illustrating waveforms of a first laser light and a second laser light according to the first embodiment;

FIGS. 3A, 3B and 3C are diagrams each illustrating a relation between timings of pulse waveforms of the first laser light and the second laser light according to the first embodiment;

FIGS. 4A, 4B and 4C are diagrams each illustrating an example of a laser irradiation range according to the first embodiment;

FIG. 5 is a time chart schematically illustrating the waveforms of the first laser light and the second laser light according to a first modified example of the first embodiment;

FIG. 6 is a block diagram illustrating the laser joining apparatus according to a second modified example of the first embodiment;

FIG. 7 is a diagram illustrating a configuration of light sources of the laser joining apparatus according to a second modified example of the first embodiment;

FIGS. 8A and 8B are diagrams each illustrating a process of a manufacturing method of a semiconductor device according to a second embodiment disclosed here;

FIGS. 9A and 9B are diagrams each illustrating the process of the manufacturing method of the semiconductor device according to the second embodiment;

FIGS. 10A and 10B are diagrams each illustrating the process of the manufacturing method of the semiconductor device according to the second embodiment;

FIGS. 11A and 11B are diagrams each illustrating the process of the manufacturing method of the semiconductor device according to the second embodiment;

FIGS. 12A and 12B are diagrams each illustrating the process of the manufacturing method of the semiconductor device according to the second embodiment;

FIGS. 13A and 13B are diagrams each illustrating the process of the manufacturing method of the semiconductor device according to the second embodiment;

FIGS. 14A and 14B are diagrams each illustrating a process of a manufacturing method of a semiconductor device according to a third embodiment disclosed here;

FIGS. 15A and 15B are diagrams each illustrating the process of the manufacturing method of the semiconductor device according to the third embodiment;

FIGS. 16A and 16B are diagrams each illustrating the process of the manufacturing method of the semiconductor device according to the third embodiment;

FIGS. 17A and 17B are diagrams each illustrating the process of the manufacturing method of the semiconductor device according to the third embodiment;

FIGS. 18A and 18B are diagrams each illustrating the process of the manufacturing method of the semiconductor device according to the third embodiment;

FIGS. 19A, 19B, 19C and 19D are diagrams each illustrating a process of a manufacturing method of an electronic device according to a fourth embodiment disclosed here; and

FIGS. 20A, 20B and 20C are diagrams each illustrating an example of a laser irradiation range.

### DETAILED DESCRIPTION

Embodiments disclosed here are described with reference to drawings. This disclosure is not limited to the following embodiments and may be appropriately changed or modified without departing from a subject matter of the disclosure. In the drawings described below, the same reference numerals designate the same or corresponding functions and description thereof may be omitted or simplified.

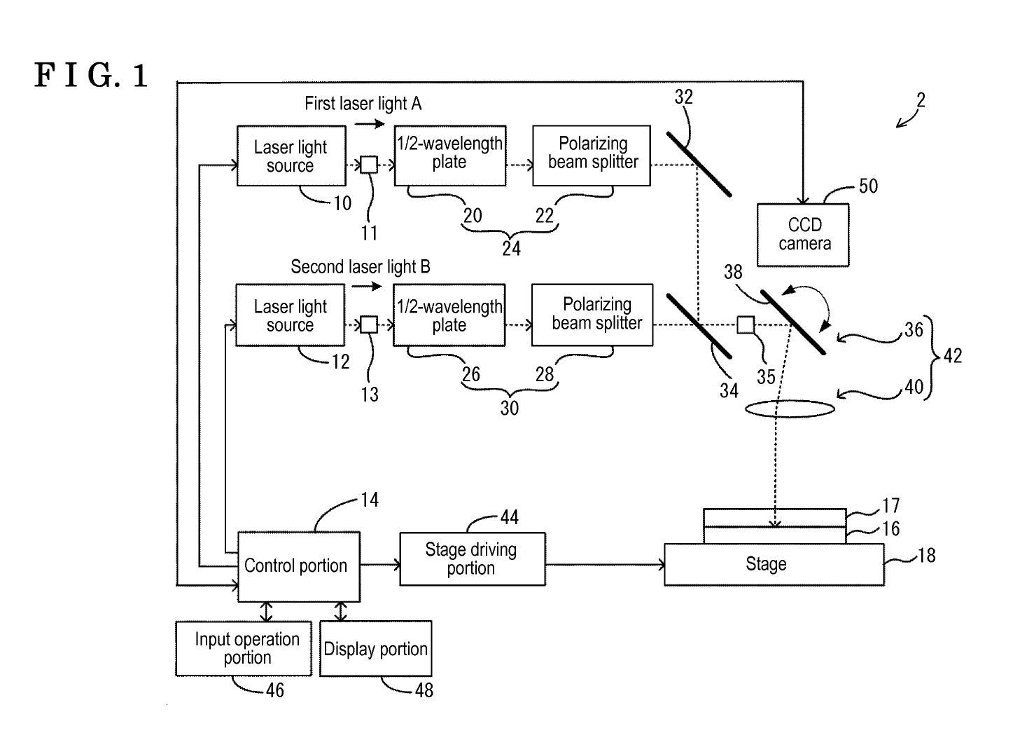

A laser joining method and a laser joining apparatus according to a first embodiment are explained with reference to FIGS. 1 to 5. In FIG. 1, connection among components of the laser joining apparatus is drawn with solid lines and an optical path of laser light is drawn with dotted lines.

A laser joining apparatus 2 in the first embodiment includes a laser light source 10 (a first laser light source) emitting a first laser light A, a laser light source 12 (a second laser light source) emitting a second laser light B, and a control portion 14 controlling the entire laser joining apparatus 2. The laser joining apparatus 2 further includes a stage 18 on which objects (workpieces, members or articles) 16 and 17 serving as targets for joining are placed. The laser joining apparatus 2 is provided at a manufacturing apparatus manufacturing an article (i.e., a product serving as a laser-joined component).

The laser joining apparatus 2 irradiates portions of the objects 16 and 17 corresponding to a region at which the objects 16 and 17 are in contact with each other or close to each other by a laser beam so as to join the objects 16 and 17 to each other. A method for joining objects by the laser beam is referred to as a laser joining method. In order to join the objects 16 and 17 serving as a first object and a second object, it is desirable that the objects 16 and 17 are securely in contact with each other, i.e., the objects 16 and 17 are in close contact with each other. Nevertheless, the objects 16 and 17 are not necessarily in close contact with each other. As long as the objects 16 and 17 are disposed sufficiently close to each other, the laser beam is irradiated to the region where the objects 16 and 17 are close to each other to thereby achieve the joining of the objects 16 and 17. In order to join the objects 16 and 17 in a state where the objects 16 and 17 are close to each other, a clearance between the objects 16 and 17 is desirably equal to or smaller than 2 μm, for example.

The control portion 14 includes a central processing unit (CPU) executing a processing including various calculations, controls, and discriminations, for example. In addition, the control portion 14 includes, for example, a read-only memory (ROM) which stores, for example, various control programs executed by the CPU. Further, the control portion 14 includes, for example, a random access memory (RAM) which temporarily stores, for example, data being processed by the CPU and input data.

An input operation portion 46 to which a user inputs a predetermined command and/or data is connected to the control portion 14. For example, a keyboard and/or various switches are used as the input operation portion 46.

A display portion 48 for performing various display is connected to the control portion 14. On the display portion 48, for example, an operation status of the laser joining apparatus 2, a status of the stage 18, an image obtained by a CCD camera 50 are displayed. For example, a liquid crystal display is used as the display portion 48.

The laser light source 10 is configured to emit the first laser light A (a first laser beam). Here, for example, a pulse laser light which is greater in pulse width than an ultrashort-pulse laser serving as the second laser light B is used, i.e., a short-pulse laser is used, as the first laser light A. For example, a nanosecond laser light is used as the first laser light A. Generally, the nanosecond laser light corresponds to a pulse laser light of which a pulse width (a time width of laser pulse) is nanosecond (ns: 10⁻⁹ second) order, i.e., the pulse width of the nanosecond laser light is equal to or greater than 1 ns and smaller than 1 μs. For example, the pulse laser light A of which the pulse width is nanosecond order is emitted from the laser light source 10. As the laser light source 10 in the present embodiment, for example, a laser oscillator of which a center wavelength is approximately 1045 nm and of which a pulse width is approximately 10 ns is used. An output power of the laser light source 10 that emits the first laser light A is approximately 100 W, for example.

In the above, the case where the pulse width of the first laser light A is approximately 10 ns is explained. The pulse width of the first laser light A, however, is not limited to 10 ns. The pulse width of the first laser light A may be appropriately set within a range between 1 ns and 900 ns, for example. In addition, the center wavelength of the first laser light A is not limited to approximately 1045 nm and may be appropriately set. Further, the output power of the laser light source 10 is not limited to approximately 100 W and may be appropriately set.

The laser light source 12 is configured to emit the second laser light B (a second laser beam). Here, for example, an ultrashort-pulse laser is used as the second laser light B. For example, a femtosecond laser light is used as the ultrashort-pulse laser light. Generally, the femtosecond laser light corresponds to a pulse laser light of which a pulse width is femtosecond (fs: 10⁻¹⁵ second) order, that is, the pulse width of the femtosecond laser light is equal to or greater than 1 fs and is smaller than 1 ps. For example, the pulse laser beam of which the pulse width is femtosecond order is emitted from the laser light source 12. As the laser light source 12 in the present embodiment, for example, a laser oscillator of which a center wavelength is approximately 1045 nm and of which a pulse width is approximately 700 fs is used. An output power of the laser light source 12 that emits the second laser light B is approximately 0.1 W to 0.5 W, for example.

The output power of the laser light source 12 that emits the second laser light B is not limited to approximately 0.1 W to 0.5 W and may be appropriately set. At this time, however, an ultrashort-pulse laser light source producing a high output is extremely expensive. In view of a reduction of cost of the laser joining apparatus 2, it is desirable to use the ultrashort-pulse laser light source 12 which is inhibited from producing a high output beyond necessity. In the present embodiment, portions of the objects 16 and 17 corresponding to a section to which the first laser light source A is irradiated is also irradiated by the second laser light source B, which is explained later. Thus, even in a case where the intensity of the second laser light B is relatively small, the objects 16 and 17 may be joined to each other.

Here, the explanation is made on a case where the pulse width of the second laser light B is approximately 700 fs, however, the pulse width of the second laser light B is not limited to approximately 700 fs. In addition, the pulse width of the second laser light B is not limited to femtosecond order and may be picosecond order. In the disclosure, the ultrashort-pulse laser light is not limited to the laser light of which the pulse width is femtosecond. The ultrashort-pulse laser light also includes the picosecond laser light of which the pulse width is equal to or smaller than several tens of picoseconds. In addition, in the disclosure, the femtosecond laser light is not limited to the laser light of which the pulse width is femtosecond. The ultrashort-pulse laser light also includes the picosecond laser light of which the pulse width is equal to or smaller than several tens of picoseconds.

In addition, the center wavelength of the second laser light B emitted from the laser light source 12 is not limited to approximately 1045 nm and may be set appropriately.

The laser light source 10 and the laser light source 12 are controlled by the control portion 14. The pulse width of the first laser light A emitted from the laser light source 10 and the pulse width of the second laser light B emitted from the laser light source 12 may be appropriately set by the user via the input operation portion 46. For example, various setting information inputted by the user is appropriately stored within a memory portion provided at the control portion 14. The control portion 14 controls the laser light source 10 and the laser light source 12 so that the first laser light A is irradiated to the region where the objects 16 and 17 are in contact with each other or close to each other and the second laser light B is irradiated to the section where the first laser light A is irradiated. Timing at which the first laser light A is emitted from the laser light source 10 and timing at which the second laser light B is emitted from the laser light source 12 may be appropriately set by the user via the input operation portion 46. The control portion 14 controls the laser light source 10 to emit the pulse of the first laser light A at a predetermined repetition frequency. In addition, the control portion 14 controls the laser light source 12 to emit the pulse of the second laser light B at a predetermined repetition frequency. The aforementioned pulse repetition frequencies of the first laser light A and the second laser light B are specified to be equal to each other and are 1 MHz, for example. The pulse repetition frequencies of the first laser light A and the second laser light B may be set appropriately by the user via the input operation portion 46.

A beam expander 11 adjusting a beam diameter of the first laser light A is provided downstream, that is, at a rear phase, of the laser light source 10 irradiating the first laser light A. A ½-wavelength plate 20 controlling a polarization direction of the first laser light A is provided downstream, that is, at a rear phase, of the beam expander 11. A polarizing beam splitter 22 adjusting the output of the first laser light A is provided downstream of the ½-wavelength plate 20. The ½-wavelength plate 20 serves as an optical element that may change the polarization direction of the laser light while being rotated. The polarizing beam splitter 22 serves as an optical element that may split a polarization component of an incident light. As the ½-wavelength plate 20 is rotated and accordingly the polarization direction of the laser light is changed, a ratio of polarization component that is split at the polarizing beam splitter 22 changes. By appropriately adjusting a rotational angle of the ½-wavelength plate 20, the power of the first laser light A emitted from the polarizing beam splitter 22 is adjusted appropriately. The ½-wavelength plate 20 and the polarizing beam splitter 22 constitute an output attenuator 24. Thus, laser intensity of the first laser light A emitted from the laser light source 10 is configured to be adjusted by the output attenuator 24. The laser intensity of the first laser light A (nanosecond laser light) may be appropriately set by the user via the input operation portion 46. The laser intensity (pulse energy) of the first laser light A adjusted by the output attenuator 24 is specified to be approximately 10 μJ/pulse to 100 μpulse, for example.

Here, the explanation is made on a case where the laser intensity of the first laser light A is adjusted by the output attenuator 24 constituted by the ½-wavelength plate 20 and the polarizing beam splitter 22, however, a mechanism adjusting the intensity of the first laser light A is not limited thereto. The intensity of the first laser light A may be adjusted appropriately by an arbitrary adjustment mechanism or adjustment device.

A beam expander 13 adjusting a beam diameter of the second laser light B is provided downstream, that is, at a rear phase, of the laser light source 12 irradiating the second laser light B. A ½-wavelength plate 26 controlling a polarization direction of the second laser light B is provided downstream, that is, at a rear phase, of the beam expander 13. A polarizing beam splitter 28 adjusting the output of the second laser light B is provided downstream of the ½-wavelength plate 26. As the ½-wavelength plate 26 is rotated and accordingly the polarization direction of the laser light is changed, a ratio of polarization component that is split at the polarizing beam splitter 28 changes. By appropriately adjusting a rotational angle of the ½-wavelength plate 26, the power of the second laser light B emitted from the polarizing beam splitter 28 is adjusted appropriately. The ½-wavelength plate 26 and the polarizing beam splitter 28 constitute an output attenuator 30. Thus, laser intensity of the second laser light B emitted from the laser light source 12 is configured to be adjusted by the output attenuator 30. The laser intensity of the second laser light B may be appropriately set by the user via the input operation portion 46 in the same way as the laser intensity of the first laser light A.

The laser intensity (pulse energy) of the second laser light B adjusted by the output attenuator 30 is specified to fall within a range not causing the objects 16 and 17 to be joined to each other in a case where the second laser light B is independently or solely irradiated to the objects 16 and 17. That is, the laser intensity (pulse energy) of the second laser light B is specified to fall within the range so that reforming is rarely generated at the portions of the objects 16 and 17 where the second laser light B is irradiated (i.e., the section) in a case where the second laser light B is independently (solely) irradiated to the objects 16 and 17. In addition, the laser intensity (pulse energy) of the second laser light B is specified to fall within the range so that the objects 16 and 17 may be jointed to each other in a case where the first laser light A is irradiated and the second laser light B is irradiated to the section to which the first laser light A is irradiated. A case where the objects 16 and 17 are inhibited from being joined to each other corresponds to a case where practically sufficient joining strength is not obtained and thus the objects 16 and 17 are substantially inhibited from being joined to each other. In a case where the objects 16 and 17 are separated from each other by a small pulling strength after the objects 16 and 17 are joined by laser (i.e., after the objects 16 and 17 are laser-joined), it is regarded that the practically sufficient joining strength is not obtained and thus the objects 16 and 17 are substantially inhibited from being joined to each other. The laser intensity (pulse energy) of the second laser light B adjusted by the output attenuator 30 is approximately 0.2 μJ/pulse, for example.

Here, the explanation is made on a case where the laser intensity of the second laser light B is adjusted by the output attenuator 30 constituted by the ½-wavelength plate 26 and the polarizing beam splitter 28, however, a mechanism adjusting the intensity of the second laser light B is not limited thereto. The intensity of the second laser light B may be adjusted appropriately by an arbitrary adjustment mechanism or adjustment device.

In the present embodiment, the laser intensity of the first laser light A and the laser intensity of the second laser light B are configured to be specified independently or separately from each other.

A mirror 32 changing an optical path of the first laser light A is provided downstream, that is, at a rear phase, of the output attenuator 24. The first laser light A emitted from the laser light source 10 and attenuated by the output attenuator 24 is reflected by the mirror 32 and is configured to enter or to be introduced to a beam splitter 34 provided downstream of the output attenuator 30. The beam splitter 34 is an optical element configured to perform multiplexing and demultiplexing, for example. In the present embodiment, the beam splitter 34 is used to multiplex the first laser light A and the second laser light B. The first laser light A attenuated by the output attenuator 24, reflected by the mirror 32 and introduced to the beam splitter 34 and the second laser light B attenuated by the output attenuator 30 and introduced to the beam splitter 34 are multiplexed by the beam splitter 34. After the multiplexing by the beam splitter 34, positions and angles of the mirror 32 and the beam splitter 34, for example, are appropriately adjusted so that a beam axis of the first laser light A and a beam axis of the second laser light B coincide with each other.

A beam expander 35 adjusting the beam diameter of the laser light is provided downstream, that is, at a rear phase, of the beam splitter 34. A galvanic scanner 36 is provided downstream of the beam expander 35. The galvanic scanner 36 is optical equipment which performs scanning with the laser beam at a high speed by appropriately changing an angle of a mirror. The first laser light A and the second laser light B entering the galvanic scanner 36 are reflected by a mirror 38 of the galvanic scanner 36 and are configured to enter or to be introduced to an Fθ (F-Theta) lens 40. In the Fθ lens 40 serving as a lens used for laser scanning, the scanning with the laser beam with which the scanning at an equal angle is conducted by a rotational mirror is achieved at a constant speed on an image plane. The galvanic scanner 36 and the Fθ lens 40 constitute a scanning optical system 42 performing two-dimensional scanning with the first laser light A or the second laser light B. The scanning optical system 42 is controlled by the control portion 14 appropriately.

The stage 18 is positioned below the Fθ lens 40. The objects 16 and 17 serving as the targets for joining are placed on the stage 18. A stage driving portion 44 for driving or actuating the stage 18 is connected to the stage 18. The control portion 14 drives the stage 18 via the stage driving portion 44. The stage 18 may be an XY-axis stage, an XYZ-axis stage or an XYZθ-axis stage.

Accordingly, in the present embodiment, the first laser light A and the second laser light B are collected or gathered to an identical point, and the scanning with the first laser light A and the second laser light B collected at the identical point is achievable.

An ambient atmosphere of the objects 16 and 17 is, for example, atmospheric air (air).

Materials of the objects 16 and 17 serving as the targets for joining are not specifically limited. Nevertheless, in a case where the first laser light A and the second laser light B are irradiated from an upper side of the object 17 in a state where the object 17 is placed on the object 16 so as to perform the laser joining, the first laser light A and the second laser light B should transmit through the object 17 to reach the region where the objects 16 and 17 are in contact with or close to each other. Thus, when the laser joining is performed in a state where the object 17 is placed on the object 16, a transparent material that is transparent relative to the first laser light A and the second laser light B is used as the material of the object 17. That is, the object 17 is a transparent member transparent relative to the first laser light A and the second laser light B. The material of the object 17 is, for example, semiconductor. The semiconductor corresponds to, for example, silicon (Si), silicon nitride (SiN), silicon carbide (SiC), gallium nitride (GaN), gallium oxide (GaO), and the like. In the disclosure, SiC, for example, is used as the material of the object 17.

The material of the object 17 is not limited to the semiconductor. The material which is transparent relative to the first laser light A and the second laser light B and on which the laser joining is achievable may be widely used as the material of the object 17. The material that is transparent relative to the first laser light A and the second laser light B is, for example, glass and semiconductor. Thus, glass may be used as the material of the object 17. The glass corresponds to, for example, alkalifree glass, blue sheet glass, white sheet glass, borosilicate glass, and silica glass.

The material of the object 16 is, for example, metal. The metal corresponds to, for example, aluminum (Al), copper (Cu), titanium (Ti), molybdenum (Mo), vanadium (V), chromium (Cr), nickel (Ni), iron (Fe), silver (Ag), tin (Sn), gold (Au), and any alloy thereof. The alloy corresponds to, for example, copper tungsten (CuW), stainless steel (SUS), invar alloy (Fe-36Ni), and kovar alloy (Fe-29Ni). A coefficient of thermal expansion of the object 16 is desirably inhibited from being greatly different from a coefficient of thermal expansion of the object 17. In a case where the coefficients are greatly different between the objects 16 and 17, a large stress is generated between the objects 16 and 17 by temperature change, which may deteriorate the joining between the objects 16 and 17.

The material of the object 16 is not limited to metal. The object 16 may be made of a transparent material that is transparent relative to the first laser light A and the second laser light B (i.e., the first laser light A and the second laser light B transmit through the object 16) or made of a material not transparent relative to the first laser light A and the second laser light B. The material on which the laser joining is achievable is widely used as the material of the object 16. For example, the object 16 may be (or may be made of) semiconductor, ceramics, glass or the like. The semiconductor corresponds to, for example, silicon (Si), SiN, SiC, GaN, GaO, and the like. The ceramics corresponds to, for example, aluminum nitride (AlN), aluminum oxide (Al₂O₃), and silicon nitride (Si₃N₄). The glass corresponds to, for example, alkalifree glass, blue sheet glass, white sheet glass, borosilicate glass, and silica glass.

The CCD camera 50 is provided above the stage 18. The image obtained by the CCD camera 50 is configured to be inputted to the control portion 14. The control portion 14 utilizes the image obtained by the CCD camera 50 to perform, for example, a positioning of the objects 16 and 17 serving as the targets for joining.

Accordingly, in the present embodiment, the first laser light A is irradiated to the objects 16 and 17 serving as the targets for joining and the second laser light B is irradiated to the portions of the objects 16 and 17 (i.e., the section) to which the first laser light A is irradiated so that the objects 16 and 17 are joined to each other. In the present embodiment, the joining is achieved by the irradiation of the first laser light A and the irradiation of the second laser light B because of the following reasons.

The simple irradiation of the second laser light B with relatively small laser intensity (pulse energy) has a difficulty in joining the objects 16 and 17. On the other hand, in a case where the first laser light A is irradiated and also the second laser light B is irradiated to the section to which the first laser light A is irradiated, the objects 16 and 17 may be joined to each other even when the laser intensity (pulse energy) of the second laser light B is relatively small. As a result, in the present embodiment, the joining is achieved by the irradiation of the first laser light A and the irradiation of the second laser light B. Even when the second laser light B is irradiated with the relatively small laser intensity, the joining between the objects 16 and 17 is achievable and therefore the laser light source 12 at a relatively reduced cost is obtainable, which contributes to a reduced cost of the laser joining apparatus 2.

In a case where the second laser light B is irradiated to the section where the first laser light A is irradiated, the objects 16 and 17 can be joined to each other even with the relatively small intensity of the second laser light B because of the following mechanism.

Even with the ultrashort-pulse laser light (the second laser light B) having the relatively small intensity, a plasma is considered to be generated in the vicinity of a focal point (a light-collecting point) of the second laser light B in a case where the ultrashort-pulse laser light (the second laser light B) is irradiated to the objects 16 and 17. In a case where the plasma is generated while the first laser light A is being irradiated, the plasma serves or functions as an absorber at which the first laser light A is absorbed (i.e., linear absorption occurs). In consequence, a large heat generation is considered to occur at the objects (objects 16 and 17). Because such large heat generation occurs within the region where the objects 16 and 17 are in contact with or close to each other, the objects 16 and 17 are considered to be securely joined to each other. According to the aforementioned reasons, in the present embodiment, the first laser light A and also the second laser light B are irradiated to the objects 16 and 17.

As mentioned above, it is considered that the plasma generated by the irradiation of the ultrashort-pulse laser light (the second laser light B) functions as the absorber relative to the first laser light A, which causes the heat generation. An area where the plasma is generated is appropriately adjustable by adjustments of power and a spot diameter of the ultrashort-pulse laser light (the second laser light B) so that a desired portion may be appropriately and locally heated.

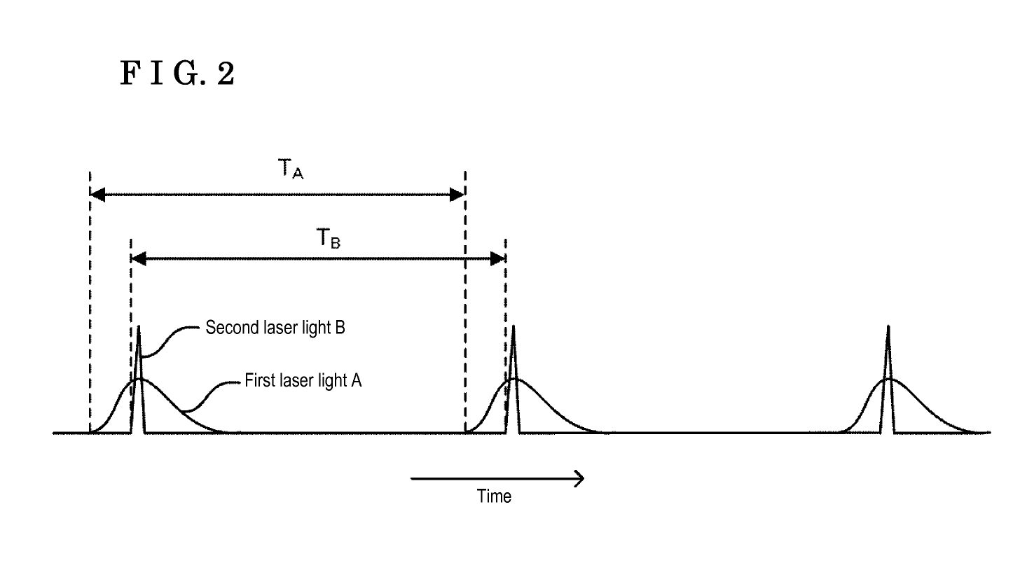

FIG. 2 is a time chart schematically illustrating waveforms (pulse waveforms) of the first laser light A and the second laser light B. As illustrated in FIG. 2, the second laser light B is irradiated in a state where the first laser light A is irradiated. In addition, a pulse repetition period T_{A} of the first laser light A and a pulse repetition period T_{B} of the second laser light B are specified to be equal to each other. That is, the pulse repetition frequency of the first laser light A and the pulse repetition frequency of the second laser light B are specified to be equal to each other.

Pulse timings of the first laser light A and the second laser light B are specified so that the first laser light A is irradiated with a certain degree of intensity at a peak time of the pulse waveform of the second laser light B.

The control portion 14 controls the laser light sources 10 and 12 so that the first laser light A and the second laser light B are irradiated at desired timings. Timings of the pulse waveforms of the first laser light A and the second laser light B may be appropriately specified by the user via the input operation portion 46.

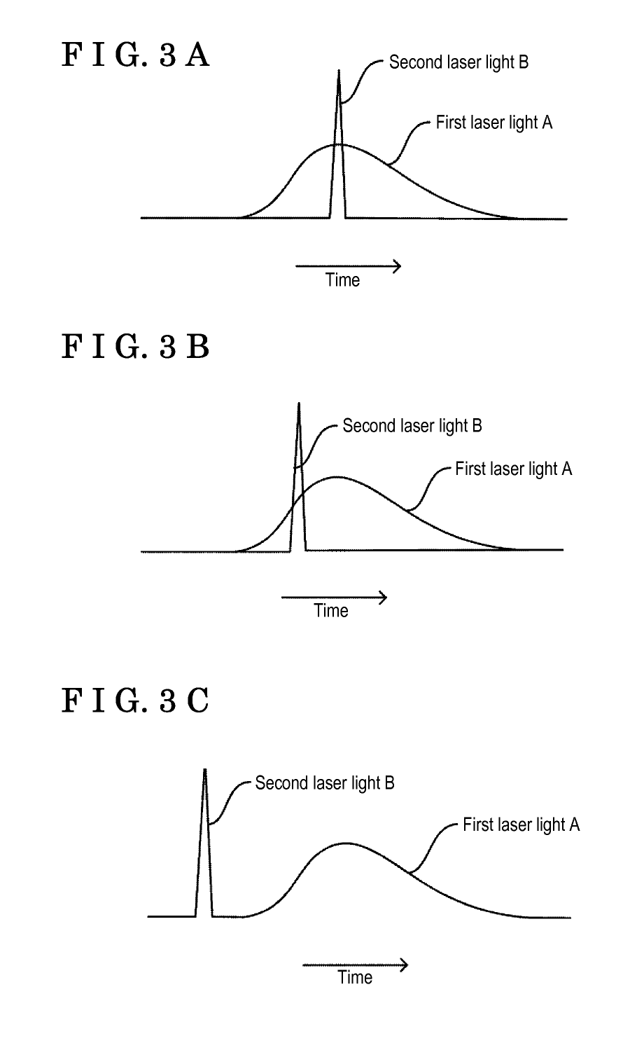

FIGS. 3A, 3B and 3C are diagrams each illustrating a relation between the timings of the pulse waveforms of the first laser light A and the second laser light B.

FIG. 3A illustrates a case where a peak time of the pulse waveform of the first laser light A and a peak time of the pulse waveform of the second laser light B match each other. As illustrated in FIG. 3A, the first laser light A is irradiated with the sufficient intensity at the peak time of the pulse waveform of the second laser light B. The intensity of the first laser light A at the peak time of the pulse waveform of the second laser light B is specified to be greater than a necessary intensity (i.e., a threshold value) for joining the objects 16 and 17.

The peak time of the pulse waveform of the first laser light A and the peak time of the pulse waveform of the second laser light B do not necessarily match each other. FIG. 3B illustrates a case where the peak time of the waveform of the second laser light B is specified to be earlier than the peak time of the waveform of the first laser light A. As illustrated in FIG. 3B, the first laser light A is irradiated with the sufficient intensity at the peak time of the pulse waveform of the second laser light B. The intensity of the first laser light A at the peak time of the pulse waveform of the second laser light B is specified to be greater than the necessary intensity for joining the objects 16 and 17.

In FIG. 3B, the peak time of the pulse waveform of the second laser light B is specified to be earlier than the peak time of the pulse waveform of the first laser light A, however, the timings of the pulse waveforms of the first laser light A and the second laser light B are not limited to the above. For example, the peak time of the pulse waveform of the second laser light B may be specified to be later than the peak time of the pulse waveform of the first laser light A. At this time, the first laser light A is desirably irradiated with the sufficient intensity at the peak time of the pulse waveform of the second laser light B. The intensity of the first laser light A at the peak time of the pulse waveform of the second laser light B is specified to be greater than the necessary intensity for joining the objects 16 and 17.

The peak time of the pulse waveform of the second laser light B is desirably specified so as not to be excessively early relative to the peak time of the pulse waveform of the first laser light A. FIG. 3C illustrates a case where the peak time of the waveform of the second laser light B is specified to be excessively early relative to the peak time of the waveform of the first laser light A. As illustrated in FIG. 3C, the first laser light A is inhibited from being sufficiently irradiated at the peak time of the pulse waveform of the second laser light B. In a case where the timings of the pulse waveforms of the first laser light A and the second laser light B are as illustrated in FIG. 3C and the laser intensity (pulse energy) of the second laser light B is relatively small, the objects 16 and 17 may not be joined to each other.

In addition, the peak time of the pulse waveform of the second laser light B is desirably specified so as not to be excessively late relative to the peak time of the pulse waveform of the first laser light A. In a case where the peak time of the pulse waveform of the second laser light B is excessively late relative to the peak time of the pulse waveform of the first laser light A, the first laser light A is not sufficiently irradiated at the peak time of the second laser light B. In a case where the first laser light A is not sufficiently irradiated at the peak time of the pulse waveform of the second laser light B, the objects 16 and 17 may not be joined to each other.

In the present embodiment, the explanation is made on a case where the scanning with the first laser light A and the second laser light B is performed by the scanning optical system 42 including the galvanic scanner 36, however, the disclosure is not limited thereto. For example, a mirror and a condenser lens may be used for the irradiation of the first laser light A and the second laser light B to the region where the objects 16 and 17 are in contact with or close to each other.

Before the start of scanning with the laser light relative to the objects 16 and 17, the positions of the objects 16 and 17 are set at predetermined positions. The control portion 14 appropriately controls the stage 18 via the stage driving portion 44, thereby positioning the objects 16 and 17 within a range in which the scanning with the laser light can be conducted by the scanning optical system 42.

The scanning of the objects 16 and 17 with the laser light is performed by controlling the scanning optical system 42. The control relative to the scanning optical system 42 is conducted by, for example, the control portion 14. The scanning optical system 42 appropriately rotates the mirror 38 of the galvanic scanner 36 and thus appropriately performs the scanning with the laser light.

The speed of scanning with the laser light can be appropriately specified by the user via the input operation portion 46. The laser light scanning speed is, for example, approximately 10 mm/s.

The focal point (light-collecting portion) of the laser light is provided, for example, at the region where the objects 16 and 17 are in contact with or close to each other. The light-collecting portion can be specified at desired portions of the objects 16 and 17 by moving the stage 18 upwardly and downwardly in a direction of a normal line on an upper surface of the stage 18.

The laser light-collecting portion does not necessarily match the region where the objects 16 and 17 are in contact with or close to each other. For example, the laser light-collecting portion may be positioned slightly upward or downward relative to the region where the objects 16 and 17 are in contact with or close to each other. Even when the laser light-collecting portion is slightly displaced from the region where the objects 16 and 17 are in contact with or close to each other, the objects 16 and 17 can be joined to each other.

The diameter of irradiation spot of the first laser light A is approximately 50 μm, for example. The diameter of irradiation spot of the second laser light B is approximately 30 μm, for example.

A planned (or target) portion to which the laser light scanning is conducted, i.e., a planned (target) laser irradiation portion, may be programmed at the control portion 14 in advance. Alternatively, the user may set the planned laser irradiation portion via the input operation portion 46 at the start of scanning with the laser light.

To start the scanning of the object 16 with the laser light, for example, the user provides an instruction to start the laser light scanning via the input operation portion 46.

In a case where the instruction to start the laser light scanning is input, the control portion 14 controls the laser light sources 10 and 12 to irradiate repeatedly the first laser light A and the second laser light B to perform the scanning with the first laser light A and the second laser light B by the scanning optical system 42. The laser light scanning is performed so that a linear trajectory, for example, is illustrated on the stage 18. The laser light scanning illustrating the linear trajectory is performed plural times in a parallel manner so that the laser light is irradiated entirely within the planned laser irradiation portion.

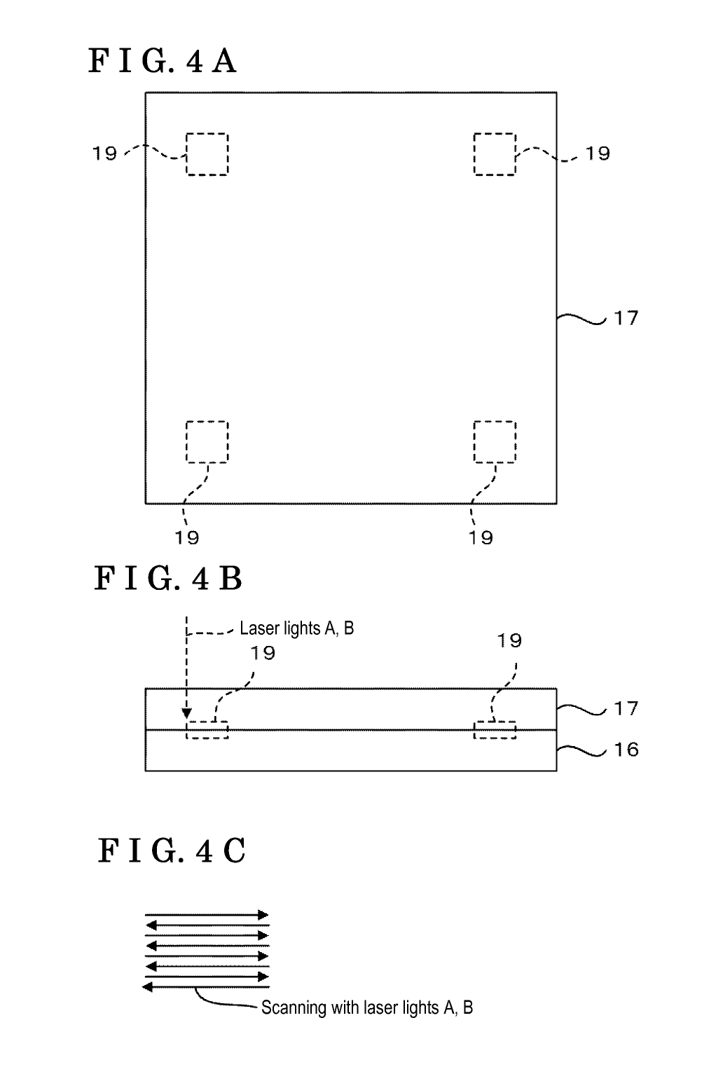

FIGS. 4A, 4B and 4C are diagrams each illustrating an example of the laser irradiation range. FIG. 4A is a plan view and FIG. 4B is a cross-sectional view. FIG. 4C is a schematic view illustrating the scanning with the laser light corresponding to a portion of each laser irradiation range 19.

As illustrated in FIG. 4A, the laser irradiation ranges 19 (i.e., planned laser irradiation ranges, joining areas or joining portions) are positioned at four corners of the objects 16 and 17, for example. Each of the laser irradiation ranges 19 includes a size of 1 mm×1 mm, for example. In a case where the scanning with the laser light is performed on one of the laser irradiation ranges 19 (i.e., selected laser irradiation range), the scanning with the laser light illustrating the linear trajectory is performed plural times in a parallel manner within the selected laser irradiation range 19 so that the laser light is entirely irradiated within the selected laser irradiation range 19. Specifically, as illustrated in FIG. 4C, in a first scanning, the laser light scanning is performed in a first direction. In a second scanning which is performed after the first scanning, the laser light scanning is performed in a second direction which is an opposite direction from the first direction. In the second scanning, a scanning path is displaced from a scanning path in the first scanning. In a third scanning, the laser light scanning is performed in the first direction in the same way as the first scanning. In the third scanning, a scanning path is displaced from the scanning path of the second scanning. Afterwards, the laser light scanning is repeated in the same way so that the laser light scanning is entirely performed within the desired (selected) laser irradiation range 19.

Generally, the irradiation intensity of the laser light is relatively strong at a center area of the irradiation spot of the laser light while being relatively weak at an area except for the center area of the irradiation spot. Thus, in a case where the laser light scanning is conducted so that the linear trajectories illustrated by the laser light are inhibited from overlapping one another, unevenness of irradiation occurs. In order to conduct the laser light irradiation without the unevenness relative to the laser irradiation range 19, it is desirable to perform the laser light scanning so that the linear trajectories illustrated by the laser light partially overlap one another.

The trajectory of the laser light is not limited to be linear and may be circular, for example.

In the above, the explanation is made on a case where the laser light is irradiated entirely within the laser irradiation range 19 by conducting the laser light scanning illustrating the linear trajectory plural times in a parallel manner. Alternatively, the laser joining may be performed without the laser light scanning, i.e., performed with the first and second laser lights A and B each of which includes a relatively large irradiation spot diameter.

After completion of the laser light irradiation over the entire laser irradiation range 19, the control portion 14 completes the emission of the first laser light A from the laser light source 10 and the emission of the second laser light B from the laser light source 12 and completes the laser light scanning by the scanning optical system 42.

The laser light scanning may be completed by an instruction provided by the user via the input operation portion 46.

Accordingly, in the present embodiment, while the first laser light A including the pulse width greater than the ultrashort-pulse laser is being irradiated to the region where the objects 16 and 17 are in contact with or close to each other, the second laser light B serving as the ultrashort-pulse laser is irradiated to the section to which the first laser light A is irradiated. At this time, the intensity (laser intensity, pulse energy) of the second laser light B falls within the range not achieving the joining between the objects 16 and 17 in a case where the second laser light B is independently or solely irradiated to the objects 16 and 17. That is, the intensity of the second laser light B falls within the range so that reforming of the objects 16 and 17 never or hardly occurs in a state where the second laser light B is independently irradiated to the objects 16 and 17. Even in a case where the intensity of the second laser light B is relatively small, the following phenomenon occurs. That is, when the second laser light B is irradiated in a state where the first laser light A is irradiated, the plasma is generated in the vicinity of the light-collecting point of the second laser light B, the plasma serving as the absorber to which the first laser light A is absorbed (i.e., linear absorption occurs). As a result, the heat generation occurs at the objects 16 and 17 to achieve the joining between the objects 16 and 17. Because the laser light source 12 that emits the second laser light B is not necessary to provide a remarkably high output, a cost reduction is achievable.

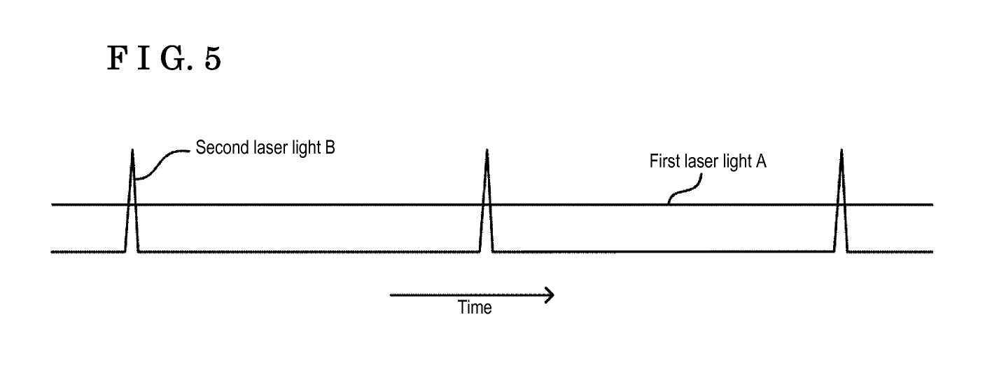

Next, a first modified example of the first embodiment is explained with reference to FIG. 5.

In the laser joining method and the laser joining apparatus according to the first modified example of the first embodiment, a continuous wave laser light is used as the first laser light A. A laser source that is configured to emit the continuous wave laser light is employed as the laser light source 10 (see FIG. 1). In addition, an ultrashort-pulse laser light, for example, is used as the second laser light B. The object 16 may be made of a transparent material transparent relative to the first laser light A and the second laser light B or of a material not transparent relative to the first laser light A and the second laser light B. Specifically, metal, semiconductor, or ceramics, for example, is used as the material forming the object 16. The object 17 may be made of a transparent material transparent relative to the first laser light A and the second laser light B. Specifically, glass or semiconductor, for example, is used as the material forming the object 17.

The intensity of the first laser light A is greater than the intensity necessary for joining the objects 16 and 17 in a state where the second laser light B is irradiated while the first laser light A is being irradiated (i.e., greater than a threshold value). The intensity of the second laser light B falls within a range so that the objects 16 and 17 are inhibited from being joined to each other in a case where the second laser light B is independently or solely irradiated to the objects 16 and 17. That is, the intensity of the second laser light B falls within the range so that reforming hardly occurs at the portions of the objects 16 and 17 to which the second laser light B is irradiated.

As illustrated in FIG. 5, in the first modified example, the first laser light A is continuously irradiated. Thus, the first laser light A is irradiated with the sufficient intensity at the peak time of the pulse waveform of the second laser light B. Even in a case where the intensity of the second laser light B is relatively small, the objects 16 and 17 can be securely joined to each other.

As mentioned above, the continuous wave laser light is usable as the first laser light A.

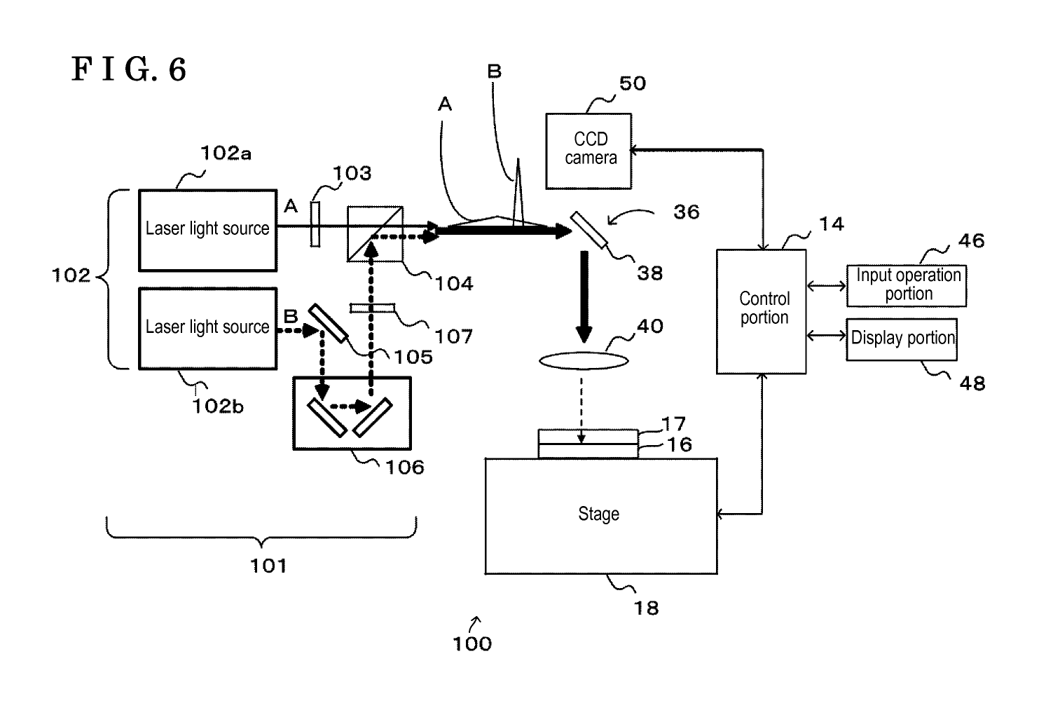

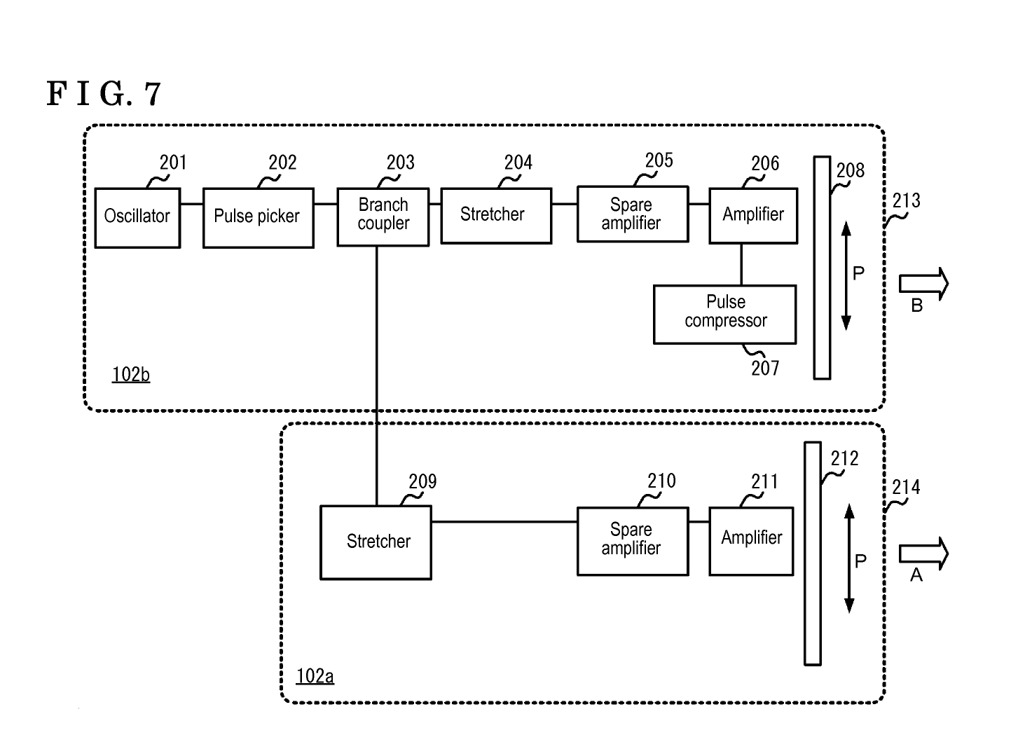

A second modified example of the first embodiment is explained with reference to FIGS. 6 and 7.

In the laser joining method and the laser joining apparatus according to the second modified example of the first embodiment, the laser light emitted from a single oscillator 201 is divided or branched to generate the first laser light A and the second laser light B.

A laser joining apparatus 100 in the second modified example includes a laser light generation apparatus 101 that is configured to emit the second laser light B (second pulse laser beam) to be delayed by a predetermined time from the emission of the first laser light A (first pulse laser beam) so that the second laser light B is spatially superimposed on the first laser light A. The laser light generation apparatus 101 includes a light source 102, a ½-wavelength plate 103, a polarizing beam splitter 104, a mirror 105, a delay circuit 106, and a ½-wavelength plate 107.

The light source 102 includes a first laser light source 102a emitting the first laser light A including the pulse width greater than the pulse width of the ultrashort-pulse laser light and a second laser light source 102b emitting the second laser light B serving as the ultrashort-pulse laser light. The light source 102 is configured to emit the first laser light A and the second laser light B in synchronization with each other.

The ½-wavelength plate 103 is provided downstream, that is, at a rear phase, of the first laser light source 102a. The polarizing beam splitter 104 is provided downstream of the ½-wavelength plate 103. In the second modified example, the ½-wavelength plate 103 is configured so that the first laser light A emitted from the first laser light source 102a is injected into the polarizing beam splitter 104 with P-polarization. Thus, the first laser light A emitted from the first laser light source 102a is P-polarized by the ½-wavelength plate 103 so as to penetrate through or transmit the polarizing beam splitter 104.

The mirror 105, the delay circuit 106 and the ½-wavelength plate 107 are provided in the mentioned order downstream, that is, at a rear phase, of the second laser light source 102b. The mirror 105, the delay circuit 106 and the ½-wavelength plate 107 are positioned so that the second laser light B reflected by the mirror 105 is injected into the polarizing beam splitter 104 via the delay circuit 106 and the ½-wavelength plate 107. In the second modified example, the ½-wavelength plate 107 is configured so that the second laser light B (the ultrashort-pulse laser light) is injected into the polarizing beam splitter 104 with S-polarization. Accordingly, the second laser light B injected into the ½-wavelength plate 107 is S-polarized by the ½-wavelength plate 107 and is then reflected by the polarizing beam splitter 104 to reach a rear phase thereof. The polarizing beam splitter 104 functions as a multiplexing portion that multiplexes the first laser light A emitted from the first laser light source 102a and the second laser light B emitted from the second laser light source 102b.

The delay circuit 106 is configured so that the second laser light B is injected into the polarizing beam splitter 104 in a delayed manner by the predetermined time relative to the first laser light A in a case where the first laser light A and the second laser light B are emitted in synchronization with each other. Therefore, in a case where the emission of the first laser light A from the first laser light source 102a and the emission of the second laser light B from the second laser light source 102b are conducted in synchronization with each other, the first laser light A and the second laser light B are emitted from the polarizing beam splitter 104 in a time difference manner by the predetermined time. That is, the emission of the second laser light B (the second laser pulse) from the polarizing beam splitter 104 is delayed by the predetermined time relative to the emission of the first laser light A (the first laser pulse).

The galvanic scanner 36, the Fθ lens 40, and the stage 18 are provided in the mentioned order downstream, that is, at a rear phase, of the polarizing beam splitter 104. Therefore, the laser light formed by and resulting from the multiplexing of the first laser light A and the second laser light B and emitted from the polarizing beam splitter 104 is reflected by the mirror 38 of the galvanic scanner 36 and is injected into the object 16 placed on the stage 18 via the Fθ lens 40.

FIG. 6 is a diagram illustrating a construction of the light source 102 of the laser joining apparatus according to the second modified example. As illustrated in FIG. 6, the second laser light source 102b includes the oscillator 201, a pulse picker 202, a branch coupler 203, a stretcher 204, a spare amplifier 205, an amplifier 206, a pulse compressor 207, and a shutter 208. The first laser light source 102a includes a stretcher 209, a spare amplifier 210, an amplifier 211, and a shutter 212. The shutter 208 is configured not to be damaged by the irradiation of the second laser light B emitted from the pulse compressor 207. In addition, the shutter 212 is configured not to be damaged by the irradiation of the first laser light A emitted from the amplifier 211.

The oscillator 201 emits the laser light at 50 MHz and 100 fs, for example. The pulse picker 202 is connected downstream, i.e., at a rear phase, of the oscillator 201 via an optical fiber. The pulse picker 202 is configured to convert the laser light at 50 MHz and 100 fs, for example, from the oscillator 201 into the laser light at 1 MHz and 100 fs, for example, to emit the converted laser light. The branch coupler 203 is connected downstream of the pulse picker 202 via an optical fiber. For example, a 3 dB-coupler is used as the branch coupler 203. A first output end of the branch coupler 203 is connected to the stretcher 204 via an optical fiber while a second output end of the branch coupler 203 is connected to the stretcher 209 via an optical fiber.

The stretcher 204 converts the laser light at 1 MHz and 100 fs emitted from the first output end of the branch coupler 203 into the laser light at 1 MHz and 100 ps. The spare amplifier 205 is connected downstream of the stretcher 204 via an optical fiber. The amplifier 206 is connected downstream of the spare amplifier 205 via an optical fiber. The pulse compressor 207 is connected downstream of the amplifier 206 via an optical fiber. The pulse compressor 207 converts the laser light emitted from the amplifier 206 into the laser light at 1 MHz and 800 fs, for example, so as to emit the converted laser light. The laser light at 1 MHz and 800 fs, for example, is emitted from an emission end 213 of the second laser light source 102b. Accordingly, the second laser light source 102b is configured to emit the second laser light B at 1 MHz and 800 fs, for example. The shutter 208 selectively opening and closing in an arrow P direction is provided downstream of the pulse compressor 207. The second laser light source 102b selectively allows and prohibits the emission of the second laser light B by the opening and closing of the shutter 208. The opening and closing of the shutter 208 is controlled by the control portion 14, for example.

The stretcher 209 converts the laser light at 1 MHz and 100 fs emitted from the second output end of the branch coupler 203 into the laser light at 1 MHz and 10 ns so as to emit the converted laser light. The spare amplifier 210 is connected downstream of the stretcher 209 via an optical fiber. The amplifier 211 is connected downstream of the spare amplifier 210 via an optical fiber. The laser light at 1 MHz and 10 ns emitted from the amplifier 211 is emitted from an emission end 214 of the first laser light source 102a. Thus, the first laser light source 102a is configured to emit the first laser light A at 1 MHz and 10 ns, for example. The shutter 212 selectively opening and closing in the arrow P direction is provided downstream of the amplifier 211. The first laser light source 102a selectively allows and prohibits the emission of the first laser light A by the opening and closing of the shutter 212. The opening and closing of the shutter 212 is controlled by the control portion 14, for example.

A length of optical path from the first output end of the branch coupler 203 to the emission end 213 of the second laser light source 102b is specified to be equal to a length of optical path from the second output end of the branch coupler 203 to the emission end 214 of the first laser light source 102a. Thus, the single laser light emitted from the single oscillator 201 is divided or branched to emit the first laser light A and the second laser light B in synchronization with each other. The length of optical path is adjustable by appropriately setting the length and/or refractive index of each optical fiber provided between the components.

As mentioned above, the laser light emitted from the single oscillator 201 may be divided or branched to generate the first laser light A and the second laser light B. In the second modified example, while the first laser light A is being irradiated to the region at which the objects 16 and 17 are in contact with or close to each other, the second laser light B is irradiated to the section where the first laser light A is irradiated, thereby achieving the joining of the objects 16 and 17.

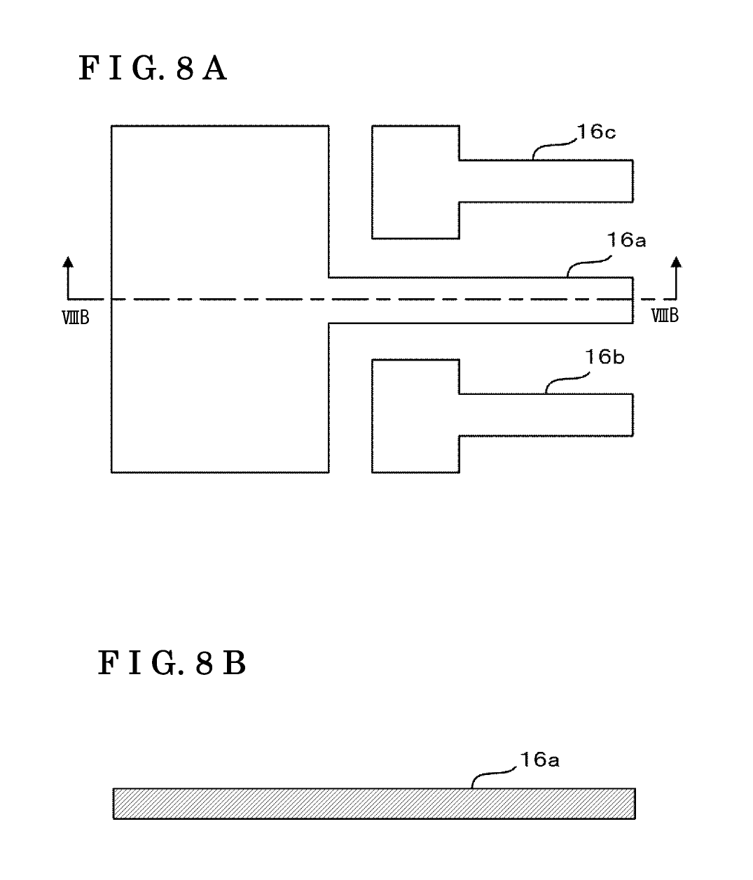

A second embodiment is explained with reference to FIGS. 8 to 13. A semiconductor device and a manufacturing method of the semiconductor device according to the second embodiment are explained with reference to FIGS. 8 to 13. FIGS. 8 to 13 are diagrams each illustrating a process of the manufacturing method of the semiconductor device. FIGS. 8A, 9A, 10A, 11A, 12A and 13A are plan views. FIGS. 8B, 9B, 10B, 11B, 12B and 13B are cross-sectional views taken along lines VIIIB-VIIIB, IXB-IXB, XB-XB, XIB-XIB, XIIB-XIIB, and XIIIB-XIIIB in FIGS. 8A, 9A, 10A, 11A, 12A and 13A, respectively. Components in the second embodiment substantially the same as the components in the laser joining method and the laser joining apparatus according to the first embodiment illustrated in FIGS. 1 to 7 bear the same reference numerals and explanation is omitted or simplified.

Here, a power semiconductor made of silicon carbide (SiC) is explained as an example, however, the disclosure is not limited to the aforementioned semiconductor and is applicable to the manufacturing method of various semiconductor devices.

As illustrated in FIG. 8A, external connection terminals 16a, 16b and 16c (lead frames or lead terminals) are prepared. The external connection terminal positioned at a center among the external connection terminals 16a, 16b and 16c, i.e., the external connection terminal 16a, serves as an external drain electrode. The external connection terminal 16b serves as an external gate electrode and the external connection terminal 16c serves as an external source electrode. The external gate electrode 16b and the external source electrode 16c are disposed at the opposed sides of the external drain electrode 16a. The external connection terminals 16a, 16b and 16c are disposed so that a relative positional relation among the external connection terminals 16a, 16b and 16c is secured by an appropriate member.

A material forming each of the external connection terminals 16a, 16b and 16c is metal, for example. A coefficient of thermal expansion of the material of each of the external connection terminals 16a, 16b and 16c and a coefficient of thermal expansion of a material forming a semiconductor chip 17a are desirably inhibited from being greatly different from each other. For example, invar or kovar serves as a material including a reduced coefficient of thermal expansion in the same way as the semiconductor chip 17a. In this case, however, an electrical resistance of invar or kovar is not sufficiently small. Thus, in a case where invar or cover is used as the material of the external connection terminals 16a, 16b and 16c, each of the external connection terminals 16a, 16b and 16c is coated by a material including a sufficiently low conductivity. The material of coating by which each of the external connection terminals 16a, 16b and 16c is coated is copper (Cu), for example. The coating made of copper is formable by plating (copper plating method), for example.

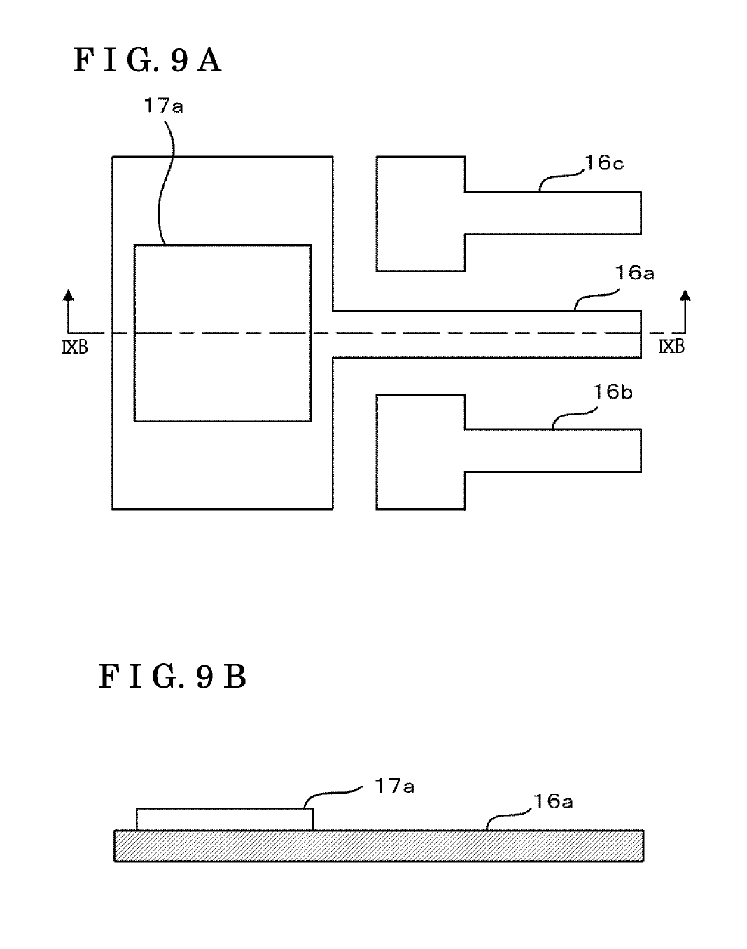

As illustrated in FIGS. 9A and 9B, the semiconductor chip 17a (power semiconductor) (i.e., the second object) is placed onto the external drain electrode 16a (i.e., the first object). SiC, for example, is used as a material of a substrate of the semiconductor chip 17a. A drain is formed at a rear side of the semiconductor chip 17a. In addition, a source and a drain are formed at a front side of the semiconductor chip 17a.

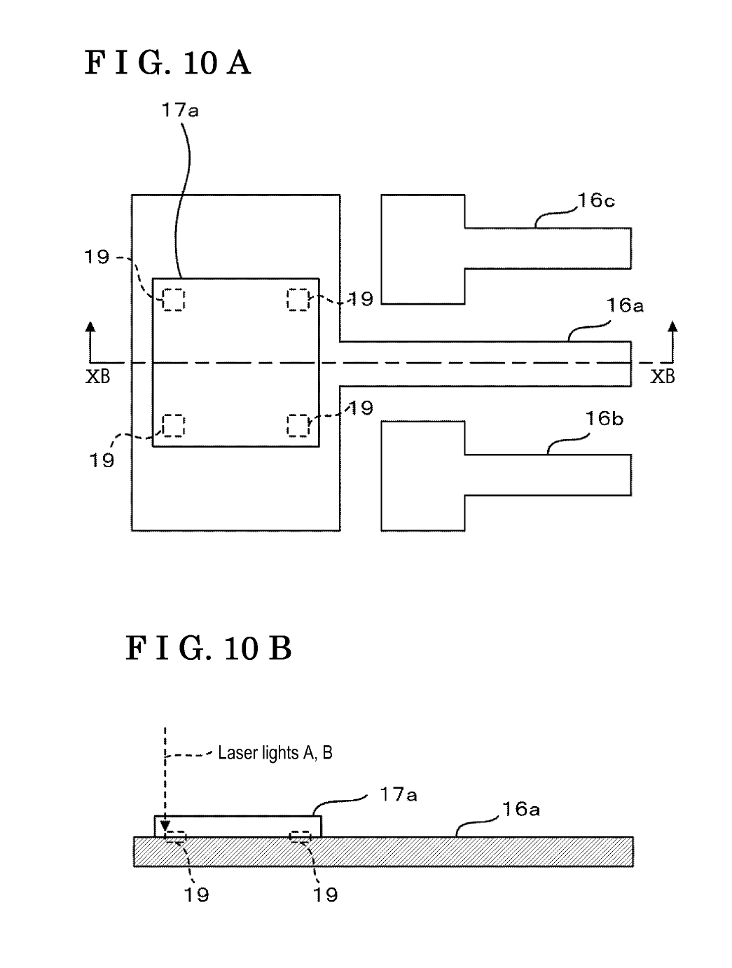

As illustrated in FIGS. 10A and 10B, the laser light is irradiated to each of the laser irradiation ranges 19 so as to join the external connection terminal 16a and the semiconductor chip 17a. The first laser light A may be the pulse laser including the larger pulse width than the ultrashort-pulse laser or be the continuous wave laser. The second laser light B is the ultrashort-pulse laser. The laser irradiation ranges 19 are placed at portions of the semiconductor chip 17a where a circuit or en electrode is not formed. The external connection terminal 16a and the semiconductor chip 17a can be joined by the laser joining method and the laser joining apparatus according to the first embodiment. That is, the semiconductor chip 17a and the external connection terminal 16a are joined to each other by the irradiation of the laser light from an upper side of the semiconductor chip 17a.

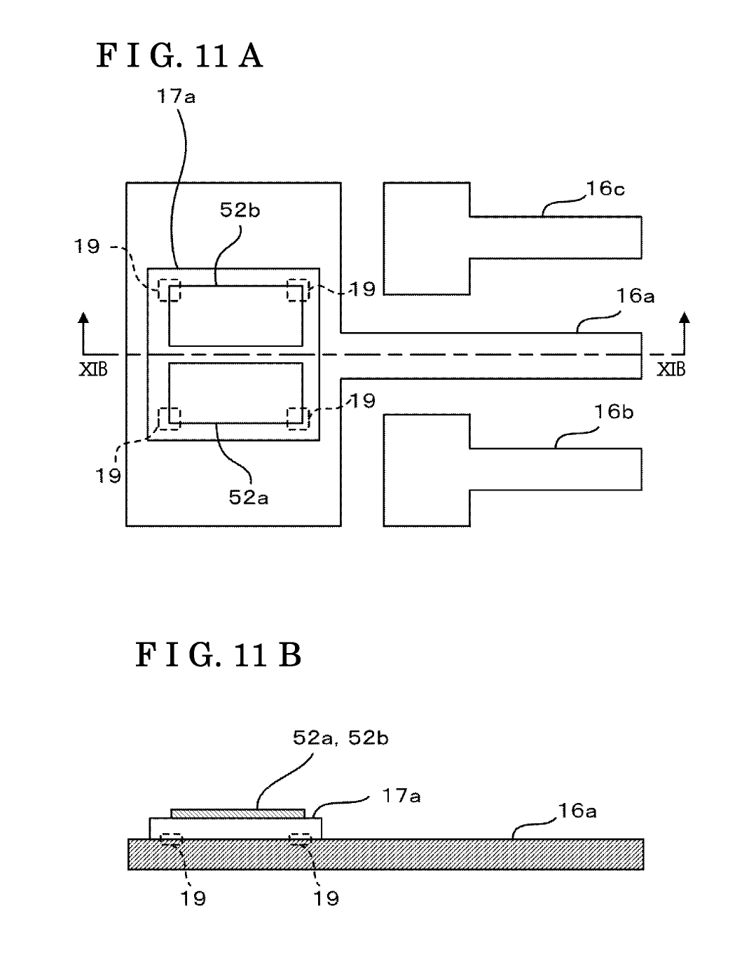

Next, as illustrated in FIGS. 11A and 11B, a gate electrode 52a and a source electrode 52b are formed onto the semiconductor chip 17a. For example, a metal film is formed by a sputtering method or the like with a use of a metal mask, for example, at which openings corresponding to planer-shapes of the gate electrode 52a and the source electrode 52b are formed so that the gate electrode 52a and the source electrode 52b are formed on the semiconductor chip 17a.

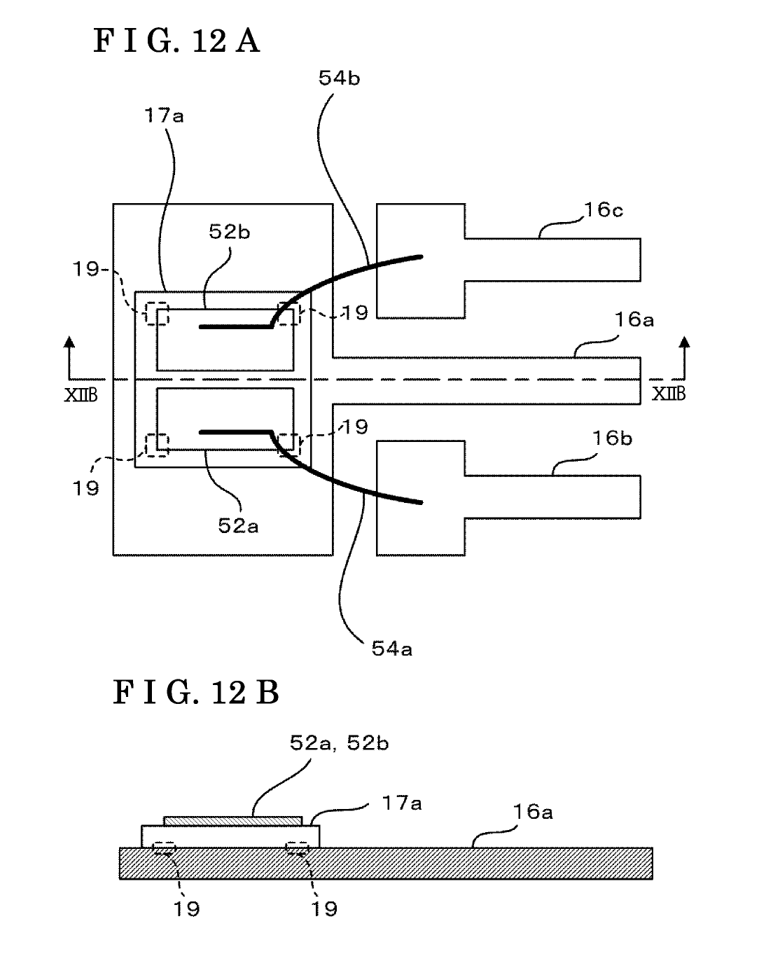

Next, as illustrated in FIGS. 12A and 12B, the gate electrode 52a and the external gate electrode 16b are electrically connected to each other by a bonding wire 54a. In addition, the source electrode 52b and the external source electrode 16c are electrically connected to each other by a bonding wire 54b. In order to connect the bonding wire 54a to the gate electrode 52a and the external gate electrode 16b, and to connect the bonding wire 54b to the source electrode 52b and the external source electrode 16c, ultrasonic wave welding, for example, is employed.

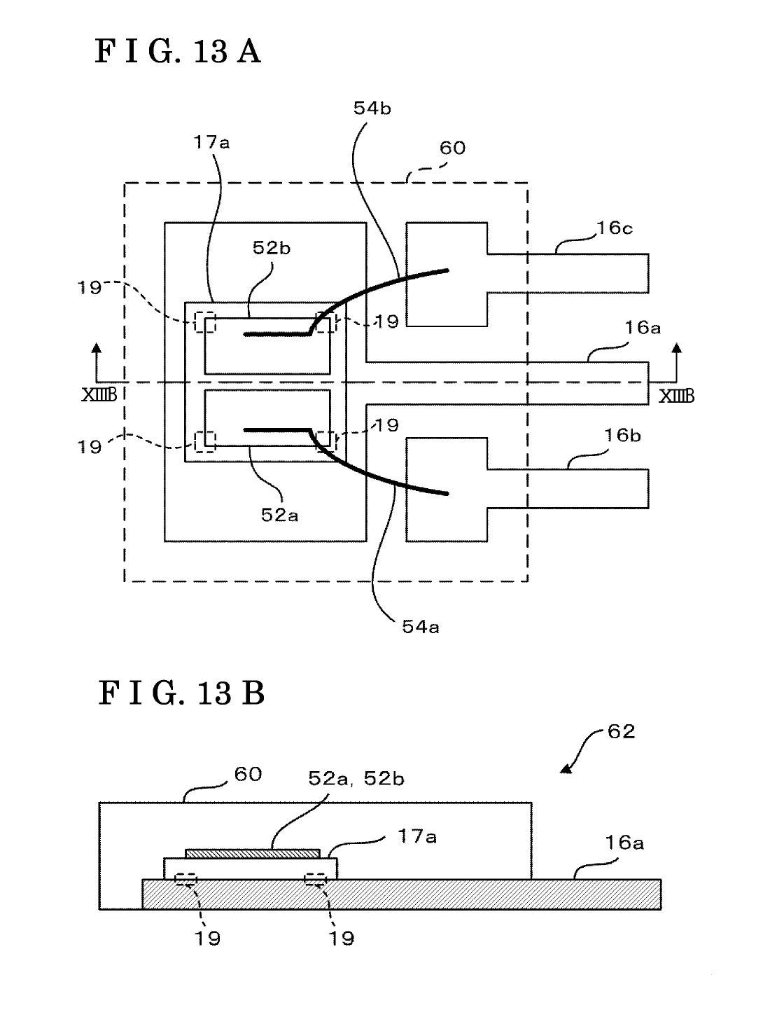

Next, as illustrated in FIGS. 13A and 13B, a molding member 60 is used for sealing. The semiconductor chip 17a, the bonding wire 54a, and the like are sealed by the molding member 60. Portions of the external connection terminals 16a, 16b and 16c protrude from the molding member 60. The molding member 60 is made of a material including a sufficiently high heat resistance. For example, a multi-component glass having a melting point of 500° C. may be used as the material of the molding member 60. For example, the multi-component glass material is heated and melted, and then is gradually cooled and harden in a state where the portions of the external connection terminals 16a, 16b and 16c protrude from the multi-component glass material so as to obtain the sealing.

In consequence, a semiconductor device 62 (the laser-joined component) in the present embodiment is manufactured.

As mentioned above, in a case where the external connection terminal 16a and the semiconductor chip 17a are joined to each other, the laser joining method in the first embodiment may be employed. In the present embodiment, without a usage of solder having a relatively low melting point, the external connection terminal 16a and the semiconductor chip 17a can be joined to each other. Thus, even when the temperature of the semiconductor chip 17a becomes high, the joining state between the external connection terminal 16a and the semiconductor chip 17a is inhibited from being deteriorated. Thus, in the present embodiment, the reliable semiconductor device can be manufactured with a simple process.

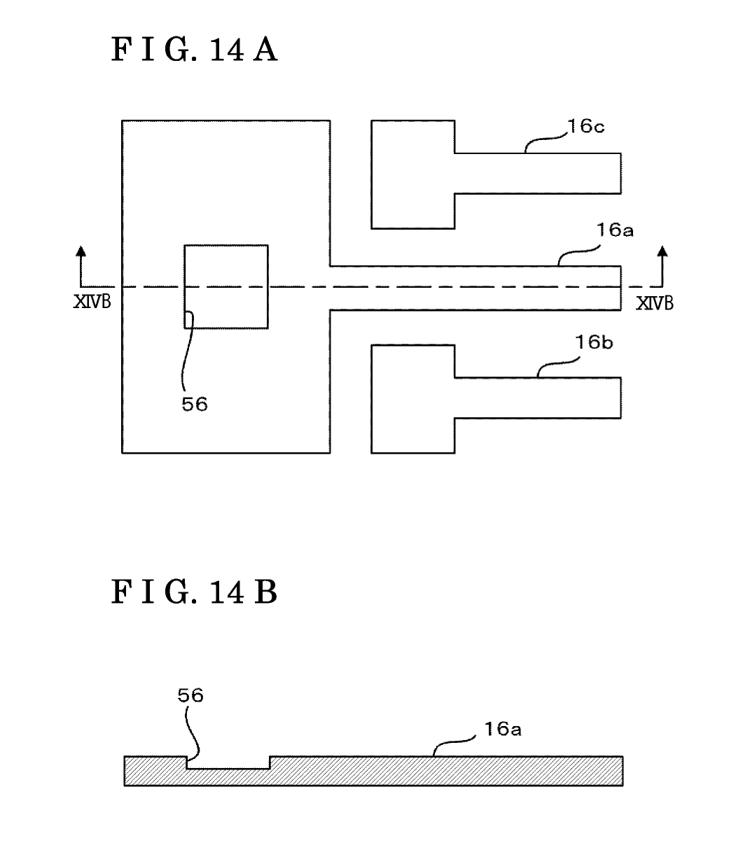

A manufacturing method of a semiconductor device according to a third embodiment is explained with reference to FIGS. 14 to 18. FIGS. 14 to 18 are diagrams each illustrating a process of the manufacturing method of the semiconductor device. FIGS. 14A, 15A, 16A, 17A, and 18A are plan views. FIGS. 14B, 15B, 16B, 17B and 18B are cross-sectional views taken along lines XIVB-XIVB, XVB-XVB, XVIB-XVIB, XVIIB-XVIIB, and XVIIIB-VXIIIB in FIGS. 14A, 15A, 16A, 17A, and 18A, respectively. Components in the third embodiment substantially the same as the components in the laser joining method and the laser joining apparatus according to the first embodiment and in the semiconductor device and the manufacturing method of the semiconductor device according to the second embodiment illustrated in FIGS. 1 to 13 bear the same reference numerals and explanation is omitted.

In the semiconductor device in the third embodiment, a recess portion 56 is filled with a solder 58 formed at the external connection terminal 16a so that a portion of a rear surface (bottom surface) of the semiconductor chip 17a is connected to the solder 58.

As illustrated in FIGS. 14A and 14B, the external connection terminals 16a, 16b and 16c (lead frames or lead terminals) are prepared. The external connection terminal positioned at a center among the external connection terminals 16a, 16b and 16c, i.e., the external connection terminal 16a, serves as an external drain electrode. The recess portion 56 is formed at the external drain electrode 16a. The recess portion 56 is formed at a center of a portion of the external drain electrode 16a where the semiconductor chip 17a is placed. The recess portion 56 is provided so as to be filled with the solder 58. The external gate electrode 16b and the external source electrode 16c are disposed at the opposed sides of the external drain electrode 16a. The external connection terminals 16a, 16b and 16c are provided so that a relative positional relation among thereof is secured by an appropriate member.

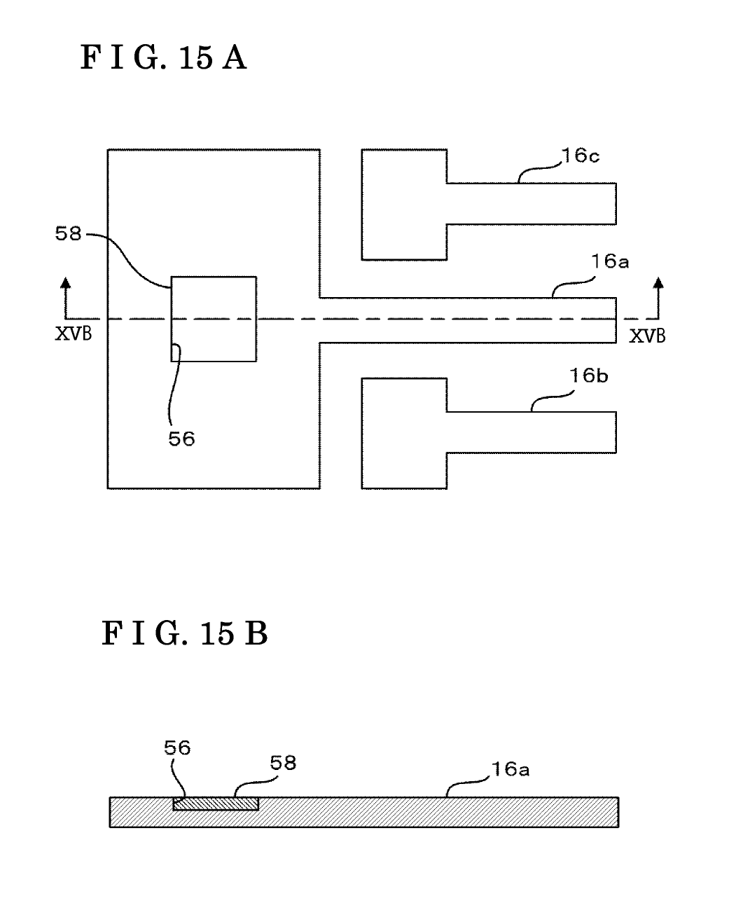

Next, as illustrated in FIGS. 15A and 15B, the recess portion 56 of the external connection terminal 16a is filled with the solder 58. The solder 58 is solidified within the recess portion 56. A contact resistance between the solder 58 that fills the recess portion 56 and the external connection terminal 16a is sufficiently small.

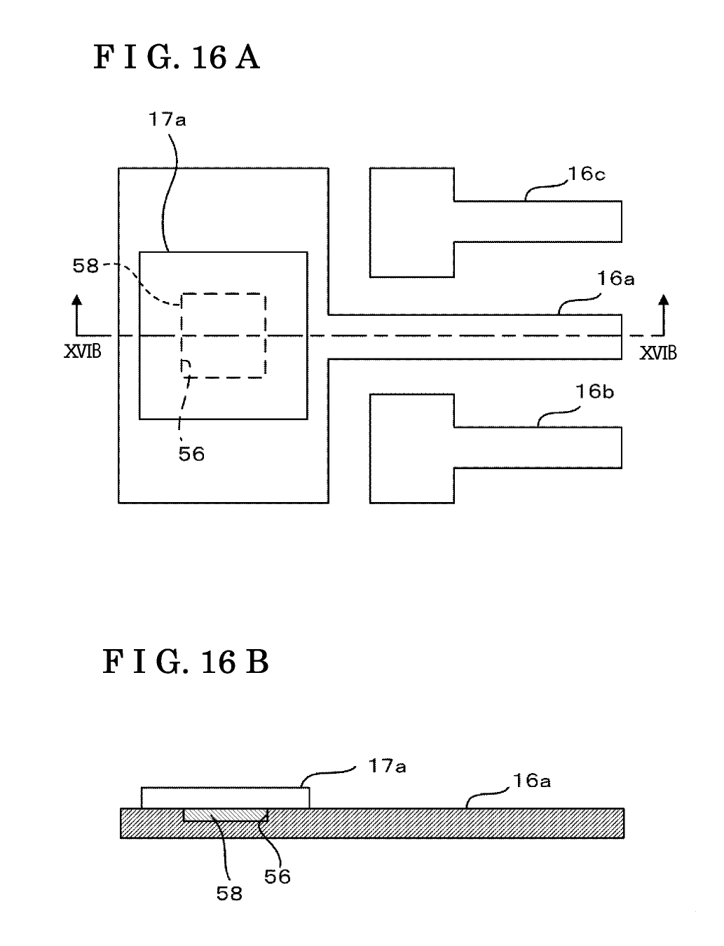

Next, as illustrated in FIGS. 16A and 16B, the semiconductor chip 17a (power semiconductor) (i.e., the second object) is placed onto the external connection terminal 16a (i.e., the first object). The solder 58 that fills the recess portion 56 makes contact with a center portion at the rear side of the semiconductor chip 17a.

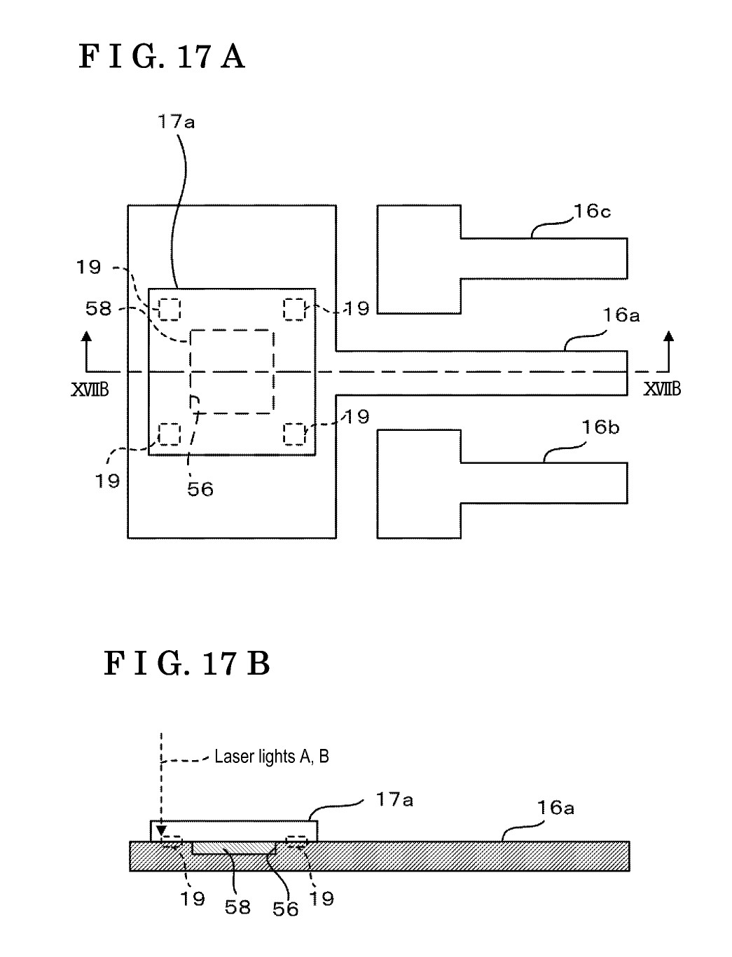

In the same way as the manufacturing method of the semiconductor device according to the second embodiment as illustrated in FIGS. 10A and 10B, the laser light is irradiated to each of the laser irradiation ranges 19 for joining the external drain electrode 16a and the semiconductor chip 17a to each other as illustrated in FIGS. 17A and 17B. The first laser light A may be the pulse laser including the larger pulse width than the ultrashort-pulse laser or be the continuous wave laser. The second laser light B is the ultrashort-pulse laser.

Then, in the same way as the manufacturing method of the semiconductor device according to the second embodiment as illustrated in FIGS. 11A and 11B, the gate electrode 52a and the source electrode 52b are formed onto the semiconductor chip 17a.

Next, in the same way as the manufacturing method of the semiconductor device according to the second embodiment as illustrated in FIGS. 12A and 12B, the gate electrode 52a and the external gate electrode 16b are electrically connected by the bonding wire 54a. In addition, the source electrode 52b and the external source electrode 16c are electrically connected by the bonding wire 54b.

Then, in the same way as the manufacturing method of the semiconductor device according to the second embodiment as illustrated in FIGS. 13A and 13B, the sealing is conducted by the molding member 60. In the same way as the manufacturing method of the semiconductor device according to the second embodiment, the molding member 60 is made of a material including a sufficiently high heat resistance. For example, a multi-component glass material including a melting point of 500° C. may be used as the material of the molding member 60. For example, the multi-component glass material is heated and melted, and then is gradually cooled and harden in a state where the portions of the external connection terminals 16a, 16b and 16c protrude from the multi-component glass material so that the sealing is achieved. The melting point of the solder 58 is lower than the melting point of the molding member 60. Thus, in a case where the sealing is conducted by the molding member 60, the solder 58 is melted, which leads to the solidification of the solder 58 at the time of cooling and hardness of the molding member 60. The contact resistance between the solder 58 and the rear surface of the semiconductor chip 17a is sufficiently small.

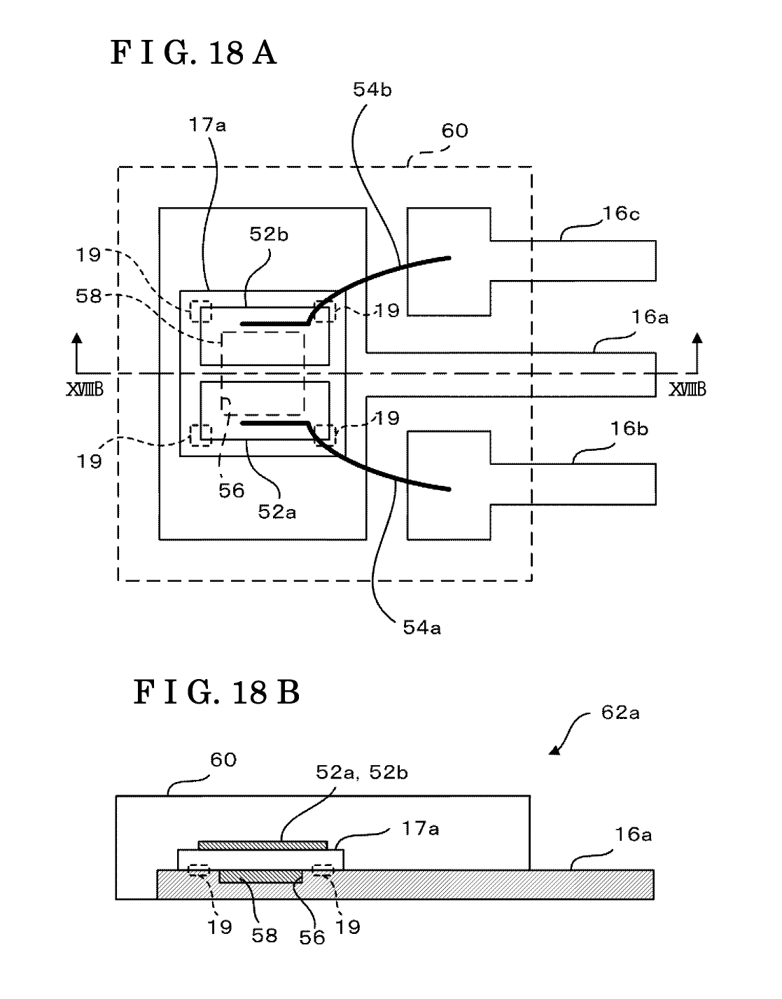

Accordingly, a semiconductor device 62a (the laser-joined component) in the present embodiment is manufactured as illustrated in FIGS. 18A and 18B.

In a case where the semiconductor device 62a manufactured in the aforementioned manner is used in practice, the temperature of the semiconductor chip 17a may become high. In a case where the temperature of the rear surface of the semiconductor chip 17a exceeds the melting point of the solder 58, the solder 58 is melted. Even when the solder 58 is melted, the solder 58 is retained within the recess portion 56, which inhibits a specific issue from being raised. Even in a case where the semiconductor device 62a is used in a state where the solder 58 is not melted, or the semiconductor device 62a is used in a state where the solder 58 is melted, the contact resistance between the solder 58 and the rear surface of the semiconductor chip 17a is maintained to be sufficiently small.

As mentioned above, the recess portion 56 formed at the external connection terminal 16a is filled with the solder 58, and the solder 58 that fills the recess portion 56 may be in contact with the rear surface of the semiconductor chip 17a. In the present embodiment, the sufficiently small contact resistance is obtainable between the semiconductor chip 17a and the external connection terminal 16a, which leads to the semiconductor device with high electrical characteristics and reliability.

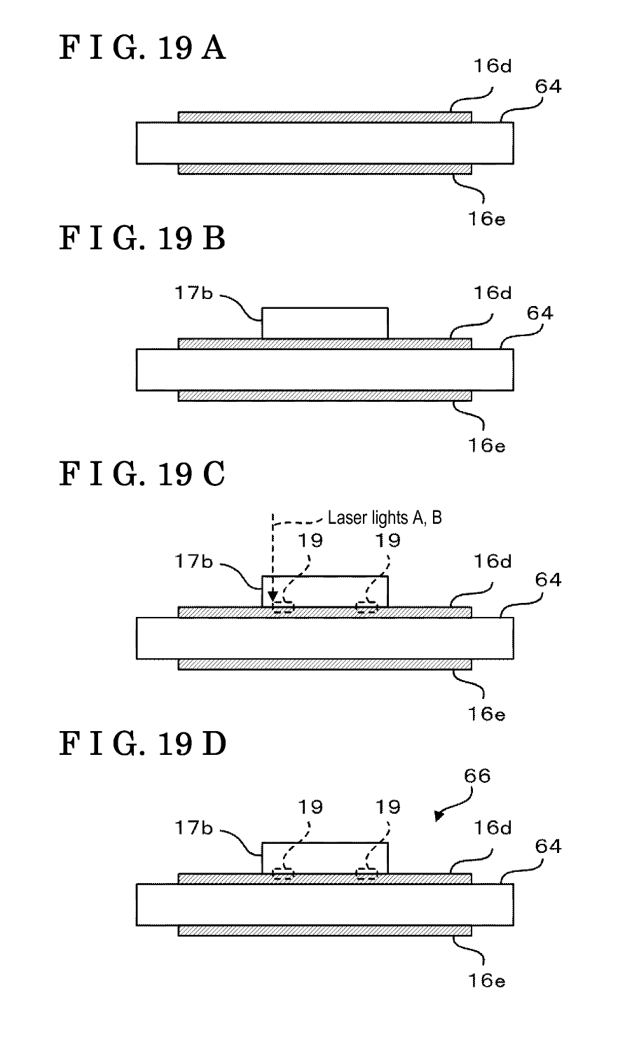

A manufacturing method of an electronic device according to a fourth embodiment is explained with reference to FIGS. 19A, 19B, 19C and 19D. FIGS. 19A, 19B, 19C and 19D are cross-sectional views illustrating a process of the manufacturing method of the electronic device. Components in the fourth embodiment substantially the same as the components in the laser joining method and the laser joining apparatus according to the first embodiment and in the semiconductor device and the manufacturing method of the semiconductor device according to the second and third embodiments illustrated in FIGS. 1 to 18 bear the same reference numerals and explanation is omitted.

As illustrated in FIG. 19A, a substrate 64 at which conductive films 16d and 16e are formed are prepared. The substrate 64 is formed by a ceramic substrate, for example. The conductive films 16d and 16e are made of copper or aluminum, for example. The conductive films 16d and 16e are formed in desired forms by patterning. In the following, a case where an electrode formed by the patterning of the conductive film 16d (i.e., electrode 16d) and a semiconductor chip 17b are laser joined to each other is explained as an example.

As illustrated in FIG. 19B, the semiconductor chip 17b (power semiconductor) (i.e., the second object) is placed onto the electrode 16d (i.e., the first object) formed onto the substrate 64.

Next, in the same way as the manufacturing method of the semiconductor device according to the second embodiment as illustrated in FIGS. 10A and 10B, the laser light (the first laser light A and the second laser light B) is irradiated to each of the laser irradiation ranges 19 for joining the electrode 16d and the semiconductor chip 17b as illustrated in FIG. 19C. The first laser light A may be the pulse laser including the larger pulse width than the ultrashort-pulse laser or be the continuous wave laser. The second laser light B is the ultrashort-pulse laser.

Accordingly, an electronic device 66 (the laser-joined component) in the present embodiment is manufactured as illustrated in FIG. 19D.

Accordingly, the disclosure may be employed in a case where the electrode 16d formed onto the substrate 64 and the semiconductor chip 17b are laser joined to each other.

The aforementioned embodiments and modified examples may be appropriately changed.

For example, the explanation is made on a case where the semiconductor device is manufactured in the second and third embodiments and the explanation is made on a case where the electronic device is manufactured in the fourth embodiment, however, cases where various products (articles) are manufactured may be achievable. For example, a case where a CCD image sensor or a CMOS image sensor, for example is sealed by a glass cap is achievable. Alternatively, a case where packaging of an organic EL device or an MEMS device, for example, is conducted is achievable.

In addition, in the aforementioned embodiments and modified examples, the explanation is made on a case where the nanosecond laser light is used as the first laser light A, however, the first laser light A is not limited to the nanosecond laser light. The pulse laser light including the larger pulse width than the second laser light B serving as the ultrashort-pulse laser may be appropriately used as the first laser light A. For example, the first laser light A may be a microsecond laser light. The microsecond laser light corresponds to a pulse laser light of which a pulse width is microsecond (μs: 10⁻⁶ second) order, that is, the pulse width of the microsecond laser light is equal to or greater than 1 us and is smaller than 1 ms. Further, the first laser light A may be a millisecond laser light. The millisecond laser light corresponds to a pulse laser light of which a pulse width is millisecond (ms: 10⁻³ second) order, that is, the pulse width of the millisecond laser light is equal to or greater than 1 ms and is smaller than 1 s.

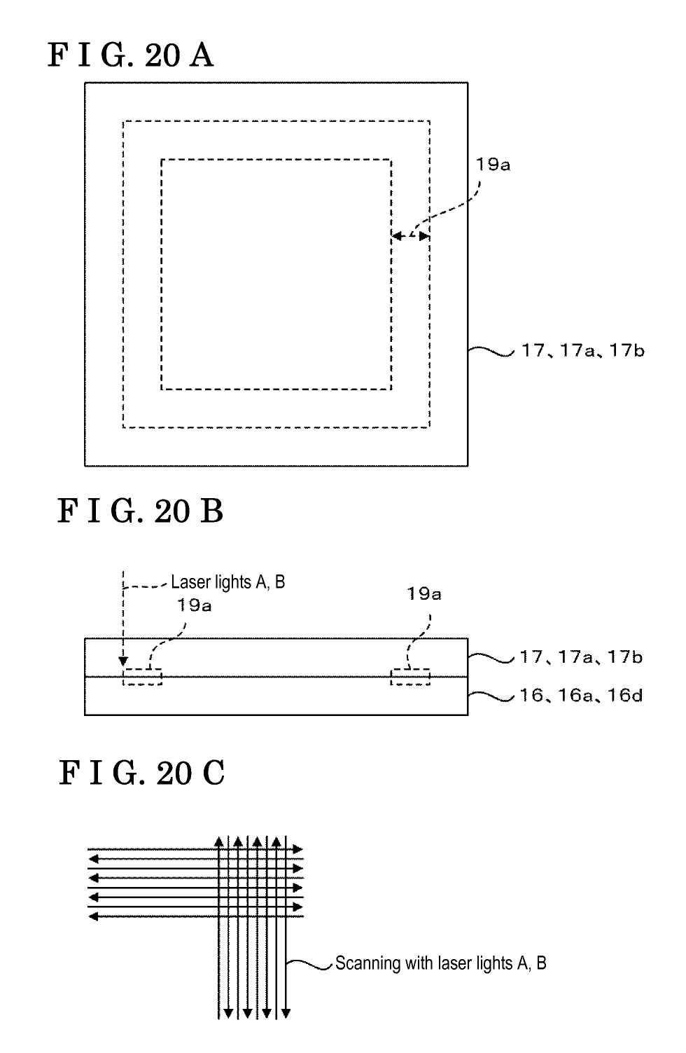

In the first to fourth embodiments, the laser irradiation ranges 19 are arranged at the four corners of the objects 17, 17a, 17b (see FIGS. 4, 10 and 17, for example), however, the laser irradiation ranges 19 are not limited to be arranged at the four corners of the objects 17, 17a, 17b. For example, as illustrated in FIGS. 20A and 20B, a laser irradiation range 19a may be arranged so as to be positioned along a peripheral edge of the object 17, 17a, 17b. FIG. 20A is a plan view and FIG. 20B is a cross-sectional view. In FIG. 20C, a corner portion of the laser irradiation range 19a is illustrated.

According to the aforementioned embodiments and the modified examples, the laser joining method includes irradiating the first laser light A serving as one of the laser light including the pulse width greater than the ultrashort-pulse laser light and the continuous wave laser light to the region at which the object 16, 16a, 16d and the object 17, 17a, 17b are in contact with or close to each other, and irradiating the second laser light B serving as the ultrashort-pulse laser light during the irradiation of the first laser light A to the section to which the first laser light A is irradiated for joining the object 16, 16a, 16d and the object 17, 17a, 17b to each other by laser joining. The intensity of the second laser light B falls within the range so that the object 16, 16a, 16d and the object 17, 17a, 17b are inhibited from being joined to each other in a case where the second laser light B is independently irradiated to the region at which the object 16, 16a, 16d and the object 17, 17a, 17b are in contact with or close to each other.

In addition, in the embodiments and modified examples, the laser-joined component (the semiconductor device 62, 62a, the electronic device 66) is obtained by the laser joining method, the laser joining method including irradiating the first laser light A serving as one of the laser light including the pulse width greater than the ultrashort-pulse laser light and the continuous wave laser light to the region at which the object 16, 16a, 16d and the object 17, 17a, 17b are in contact with or close to each other, and irradiating the second laser light B serving as the ultrashort-pulse laser light during the irradiation of the first laser light A to the section to which the first laser light A is irradiated for joining the object 16, 16a, 16d and the object 17, 17a, 17b to each other by laser joining. The intensity of the second laser light B falls within the range so that the object 16, 16a, 16d and the object 17, 17a, 17b are inhibited from being joined to each other in a case where the second laser light B is independently irradiated to the region at which the object 16, 16a, 16d and the object 17, 17a, 17b are in contact with or close to each other.

Further, in the embodiments and modified examples, the laser joining apparatus 2, 100 includes the first laser light source 10, 102a emitting the first laser light A serving as one of the laser light including the pulse width greater than the ultrashort-pulse laser light and the continuous wave laser light, the second laser light source 12, 102b emitting the second laser light B serving as the ultrashort-pulse laser light, and the control portion 14 irradiating the first laser light A to the region at which the object 16, 16a, 16d and the object 17, 17a, 17b are in contact with or close to each other and irradiating the second laser light B during the irradiation of the first laser light A to the section to which the first laser light A is irradiated. The intensity of the second laser light B falls within the range so that the object 16, 16a, 16d and the object 17, 17a, 17b are inhibited from being joined to each other in a case where the second laser light B is independently irradiated to the region at which the object 16, 16a, 16d and the object 17, 17a, 17b are in contact with or close to each other.

Accordingly, while the first laser light A including the pulse width greater than the ultrashort-pulse laser or the continuous wave laser light is being irradiated to the region where the object 16, 16a, 16d and the object 17, 17a, 17b are in contact with or close to each other, the second laser light B serving as the ultrashort-pulse laser is irradiated to the section to which the first laser light A is being irradiated. At this time, the intensity (laser intensity, pulse energy) of the second laser light B falls within the range not achieving the joining between the object 16, 16a, 16d and the object 17, 17a, 17b, i.e., falls within the range so that the object 16, 16a, 16d and the object 17, 17a, 17b are inhibited from being joined to each other, in a case where the second laser light B is independently or solely irradiated to the object 16, 16a, 16d and the object 17, 17a, 17b, specifically to the region where the object 16, 16a, 16d and the object 17, 17a, 17b are in contact with or close to each other. That is, the intensity of the second laser light B falls within the range so that reforming of the object 16, 16a, 16d and the object 17, 17a, 17b never or hardly occurs in a state where the second laser light B is independently irradiated to the object 16, 16a, 16d and the object 17, 17a, 17b. Even in a case where the intensity of the second laser light B is relatively small, the following phenomenon occurs. That is, when the second laser light B is irradiated in a state where the first laser light A is irradiated, the plasma is generated in the vicinity of the light-collecting point of the second laser light B, the plasma serving as the absorber to which the first laser light A is absorbed (i.e., linear absorption occurs). As a result, the heat generation occurs at the object 16, 16a, 16d and the object 17, 17a, 17b to achieve the joining between the object 16, 16a, 16d and the object 17, 17a, 17b. Because the laser light source 12 that emits the second laser light B is not necessary to provide a remarkably high output, a cost reduction is achievable.

In the embodiments and modified examples, the laser light including the pulse width greater than the ultrashort-pulse laser light is a nanosecond laser light and the second laser light B is a femtosecond laser light.

In the embodiments and modified examples, the object 16, 16a, 16d and the object 17, 17a, 17b are in contact with or close to each other in a state where the object 17, 17a, 17b is arranged at an upper side of the object 16, 16a, 16d. The first laser light A is irradiated from an upper side of the object 17, 17a, 17b and the second laser light B is irradiated from an upper side of the object 17, 17a, 17b.

In the embodiments and modified examples, the second laser light B generates a plasma.

In the embodiments and modified examples, the object 16, 16a, 16d is one of metal, semiconductor and ceramics, and the object 17, 17a, 17b is the transparent member transparent relative to the first laser light A and the second laser light B.

In the third embodiment, the external connection terminal (external drain electrode) (object) 16a includes the recess portion 56 at a portion of an area of the external connection terminal 16a, the area where the semiconductor chip (object) 17a overlaps the external connection terminal 16a, the recess portion 56 being filled with the solder 58. The external connection terminal 16a and the semiconductor chip 17a are joined to each other by laser joining at a portion of the semiconductor chip 17a except for a portion where the semiconductor chip 17a overlaps the recess portion 56.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A laser joining method comprising:
irradiating a first laser light serving as one of a laser light including a pulse width greater than an ultrashort-pulse laser light and a continuous wave laser light to a region at which a first object and a second object are in contact with or close to each other; and
irradiating a second laser light serving as the ultrashort-pulse laser light during the irradiation of the first laser light to a section to which the first laser light is irradiated for joining the first object and the second object to each other by laser joining, wherein
an intensity of the second laser light falls within a range so that the first object and the second object are inhibited from being joined to each other in a case where the second laser light is independently irradiated to the region at which the first object and the second object are in contact with or close to each other.

2. The laser joining method according to claim 1, wherein the laser light including the pulse width greater than the ultrashort-pulse laser light is a nanosecond laser light and the second laser light is a femtosecond laser light.

3. The laser joining method according to claim 1, wherein
the first object and the second object are in contact with or close to each other in a state where the second object is arranged at an upper side of the first object,
the first laser light is irradiated from an upper side of the second object,
the second laser light is irradiated from an upper side of the second object.

4. The laser joining method according to claim 1, wherein the second laser light generates a plasma.

5. The laser joining method according to claim 1, wherein
the first object is one of metal, semiconductor and ceramics, and the second object is a transparent member transparent relative to the first laser light and the second laser light.

6. The laser joining method according to claim 1, wherein
the first object includes a recess portion at a portion of an area of the first object, the area where the second object overlaps the first object, the recess portion being filled with a solder,
the first object and the second object are joined to each other by laser joining at a portion of the second object except for a portion where the second object overlaps the recess portion.

7. A laser-joined component obtained by a laser joining method, the laser joining method comprising:
irradiating a first laser light serving as one of a laser light including a pulse width greater than an ultrashort-pulse laser light and a continuous wave laser light to a region at which a first object and a second object are in contact with or close to each other; and
irradiating a second laser light serving as the ultrashort-pulse laser light during the irradiation of the first laser light to a section to which the first laser light is irradiated for joining the first object and the second object to each other by laser joining, wherein
an intensity of the second laser light falls within a range so that the first object and the second object are inhibited from being joined to each other in a case where the second laser light is independently irradiated to the region at which the first object and the second object are in contact with or close to each other.

8. A laser joining apparatus comprising:
a first laser light source emitting a first laser light serving as one of a laser light including a pulse width greater than an ultrashort-pulse laser light and a continuous wave laser light;
a second laser light source emitting a second laser light serving as the ultrashort-pulse laser light; and
a control portion irradiating the first laser light to a region at which a first object and a second object are in contact with or close to each other and irradiating the second laser light during the irradiation of the first laser light to a section to which the first laser light is irradiated, wherein
an intensity of the second laser light falls within a range so that the first object and the second object are inhibited from being joined to each other in a case where the second laser light is independently irradiated to the region at which the first object and the second object are in contact with or close to each other.

9. The laser joining apparatus according to claim 8, wherein the second laser light generates a plasma.
